(19) United States
(12) Patent Application Publication
(10) Pub. No.: US 2018/0221779 A1
(43) Pub. Date: Aug. 9, 2018

(54) FIGURE AND FIGURE SYSTEM

(71) Applicant: Speecys Corp., Tokyo (JP)

(72) Inventor: Tomoaki KASUGA, Tokyo (JP)

(21) Appl. No.: 15/749,878

(22) PCT Filed: Jul. 28, 2016
(86) PCT No.: PCT/JP2016/072206

§ 371 Date: Feb. 2, 2018

(30) Foreign Application Priority Data
Aug. 6, 2015 (JP) 2015-156181

(51) Int. Cl. A63H 3/46; A63H 13/04; A63H 29/22; A63H 31/10; G09F 19/08

(52) U.S. Cl. CPC A63H 3/46; A63H 13/04; G09F 19/08; A63H 31/10; A63H 29/22

(57) ABSTRACT

A figure system includes a drive unit including a plurality of actuators, and a figure including one or a plurality of axial joint mechanisms. The axial joint mechanisms each include a rotary part that is provided rotatably around a rotation axis. Drive force derived from one of the plurality of actuators is transmitted to corresponding one of the plurality of axial joint mechanisms through a wire. The rotary part has an arc shape at least in a part of an outer edge in a cross-section that is orthogonal to the rotation axis.

### CROSS-REFERENCE TO RELATED APPLICATIONS

This application is a Section 371 of International Application No. PCT/JP2016/072206, filed Jul. 28, 2016, which was published in the Japanese language on Feb. 9, 2017, under International Publication No. WO 2017/022635 A1, which claims priority under 35 U.S.C. § 119(b) to Japanese Application No. 2015-156181, filed Aug. 6, 2015, the disclosures of each of which are incorporated herein by reference in their entirety.

### BACKGROUND OF THE INVENTION

### Technical Field

The disclosure relates to a movable figure system that makes it possible to perform a predetermined motion, and a figure used for the figure system.

Figures that represent animation characters, athletes, animals, etc., as their motif have been manufactured, sold, etc., as personal luxuries, for example. There have been already proposed figures that include drivers and movable parts. For example, reference is made to Patent Literatures 1 and 2.

### CITATION LIST

### Patent Literature

Patent Literature 1: Japanese Unexamined Patent Application Publication No. 2003-325992

Patent Literature 2: Japanese Unexamined Utility Model Application Publication No. H05-68594

However, a doll toy and a doll disclosed respectively in Patent Literatures 1 and 2, etc., are each extremely simple in its motion and each may possibly involve difficulties in increasing a degree of freedom of its motion.

To increase a degree of freedom of a motion of a doll, etc., one method in an example of a humanoid robot may be to provide a servomotor or the like for each joint and drive the joints by means of drive force derived from each of the servomotors. This, on the other hand, results in an increase in weight of each of the joints, leading to, for example, a necessity of mounting a large-sized servomotor having larger output on each shoulder joint due to an increase in weight of joints that correspond to elbows. This in turn results potentially in a vicious circle of a further increase in overall size and weight. Another concern is an annoying noise attributed to driving of the servomotors.

It is therefore desirable to provide a figure system that makes it possible to achieve a wide variety of motions while ensuring aesthetic appearance, and a figure used for the figure system.

### BRIEF SUMMARY OF THE INVENTION

A first figure system according to an embodiment of the disclosure includes: a drive unit including a plurality of actuators; and a figure including one or a plurality of axial joint mechanisms. The axial joint mechanisms each include a rotary part that is provided rotatably around a rotation axis. Here, drive force derived from one of the plurality of actuators is transmitted to corresponding one of the plurality of axial joint mechanisms through a wire. Further, the rotary part has an arc shape at least in a part of an outer edge in a cross-section that is orthogonal to the rotation axis.

A first figure according to an embodiment of the disclosure includes: one or a plurality of axial joint mechanisms each including a rotary part that is provided rotatably around a rotation axis; a detachment unit configured to be coupled to a drive unit including a plurality of actuators; and a wire that extends from corresponding one of the plurality of axial joint mechanisms to the detachment unit. Here, the rotary part has an arc shape at least in a part of an outer edge in a cross-section that is orthogonal to the rotation axis.

The first figure system and the first figure according to the respective embodiments of the disclosure, the rotary part in the axial joint mechanism includes the arc part at least in a part of the outer edge in the cross-section that is orthogonal to the rotation axis. This, for example, allows for easing of interference with clothing or covering that covers the figure upon operation. Hence, it becomes possible to perform a wider variety of motions of the figure stably and smoothly.

A second figure system according to an embodiment of the disclosure includes: a drive unit including a plurality of actuators; and a figure including a plurality of modules that are coupled together and each include one or a plurality of axial joint mechanisms. Here, drive force derived from one of the plurality of actuators is transmitted to corresponding one of the plurality of axial joint mechanisms through a wire.

A second figure according to an embodiment of the disclosure includes: a plurality of modules that are coupled together, and each include one or a plurality of axial joint mechanisms; a detachment unit configured to be coupled to a drive unit including a plurality of actuators; and a wire that extends from corresponding one of the plurality of axial joint mechanisms to the detachment unit.

The second figure system and the second figure according to the respective embodiments of the disclosure each include a plurality of modules that are coupled together, and each include one or a plurality of axial joint mechanisms. This makes it easy to perform an assembly operation upon manufacturing. Further, replacement on a module basis becomes possible, thus allowing for easy repair and type change depending on a specification or preference.

According to the figure system of an embodiment of the disclosure, it is possible to achieve a wide variety of motions of the figure while ensuring aesthetic appearance of the figure. Further, the figure according to an embodiment of the disclosure is usable for the figure system. Note that effects of the disclosure are not limited to those described above. Any of effects to be described hereinbelow may be exhibited as well.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1A is a schematic illustration of an overall configuration of a figure system according to a first embodiment.

FIG. 1B is a block diagram describing an internal mechanism of the figure system of FIG. 1A.

FIG. 1C is a schematic illustration of an appearance of, and a framework inside, the figure illustrated in FIG. 1A.

FIG. 1D is a schematic illustration of an appearance of the figure illustrated in FIG. 1A as viewed obliquely from a rear side.

FIG. 1E is an exploded view of parts of the figure illustrated in FIG. 1A.

FIG. 1F is a perspective view of an example appearance of the figure system of FIG. 1A upon its operation.

FIG. 1G is an enlarged schematic diagram of an appearance of an upper part of the figure illustrated in FIG. 1A.

FIG. 2A is an enlarged perspective view of a hand joint, as well as its vicinity, of the figure illustrated in FIG. 1A.

FIG. 2B is an enlarged perspective view of an appearance of the hand joint of the figure illustrated in FIG. 2A.

FIG. 2C depicts an operation of a hand of the figure illustrated in FIG. 2A.

FIG. 2D depicts another operation of the hand of the figure illustrated in FIG. 2A.

FIG. 2E is an enlarged exploded perspective view of the hand joint of the figure illustrated in FIG. 2A.

FIG. 2F is another enlarged exploded perspective view of the hand joint of the figure of FIG. 2A.

FIG. 3A is an enlarged perspective view of an appearance of a part of a left leg of the figure of FIG. 1A.

FIG. 3B is an enlarged perspective view of an appearance of a knee joint of the figure of FIG. 3A.

FIG. 3C is an enlarged exploded perspective view of the knee joint of the figure of FIG. 3A.

FIG. 3D is a side view for describing an operation of the knee joint of the figure of FIG. 3A.

FIG. 3E is a side view for describing an operation of the left leg of the figure of FIG. 3A.

FIG. 3F is an enlarged perspective view of an appearance of a main part of the knee joint of the figure of FIG. 3A.

FIG. 3G is an enlarged side view of an appearance of the main part of the knee joint of the figure of FIG. 3A.

FIG. 4A is a first conceptual diagram that describes a mechanism of transmitting power from a driver to a joint in the figure system of FIG. 1A.

FIG. 4B is a timing chart for describing an operation performed by a controller in the figure system of FIG. 1A.

FIG. 4C is a second conceptual diagram that describes a mechanism of transmitting the power from the driver to a joint in the figure system of FIG. 1A.

FIG. 5 is a conceptual diagram illustrating a main part of a figure system according to a first modification example of the first embodiment.

FIG. 6A is a perspective view of a main part of a figure system according to a second modification example of the first embodiment.

FIG. 6B is a side view of a main part of the figure system according to the second modification example of the first embodiment.

FIG. 7A is a first explanatory diagram illustrating a configuration of a main part of a figure system according to a second embodiment.

FIG. 7B is a second explanatory diagram illustrating a configuration of a main part of the figure system according to the second embodiment.

FIG. 7C is a third explanatory diagram illustrating a configuration of a main part of the figure system according to the second embodiment.

FIG. 8 schematically illustrates an overall configuration of a figure system according to a third embodiment.

FIG. 9 is a schematic cross-sectional view of a part of the figure system according to the third embodiment.

FIG. 10A is a front view of first other modification example in the figure system according to the disclosure.

FIG. 10B is a side view of the first other modification example illustrated in FIG. 10A.

FIG. 11A is a front view of second other modification example in the figure system according to the disclosure.

FIG. 11B is a side view of the second other modification example illustrated in FIG. 11A.

FIG. 12 schematically illustrates third other modification example in the figure system according to the disclosure.

FIG. 13 schematically illustrates fourth other modification example in the figure system according to the disclosure.

### DETAILED DESCRIPTION OF THE INVENTION

In the following, some embodiments of the disclosure are described in detail, in the following order, with reference to the drawings.

1. First Embodiment (A Figure System Having a Basic Configuration)
(1) Example of Basic Configuration of Figure System
(2) Example of Detailed Configuration of Joints
(3) Example of Basic Operation of Figure System
(4) Example of Operation of Joint
(5) Workings and Effects

2. Modification Examples of First Embodiment
(1) Modification Example 1-1
(2) Modification Example 1-2

3. Second Embodiment (A Figure System in which a Figure Unit is Detachably Held by a Base Unit)
(1) Configuration of Detachment Unit
(2) Workings and Effects

4. Third Embodiment (A Figure System Including a Figure Configured by a Plurality of Modules)

5. Other Modification Examples

<1. First Embodiment>

[1. Example of Basic Configuration of Figure System]

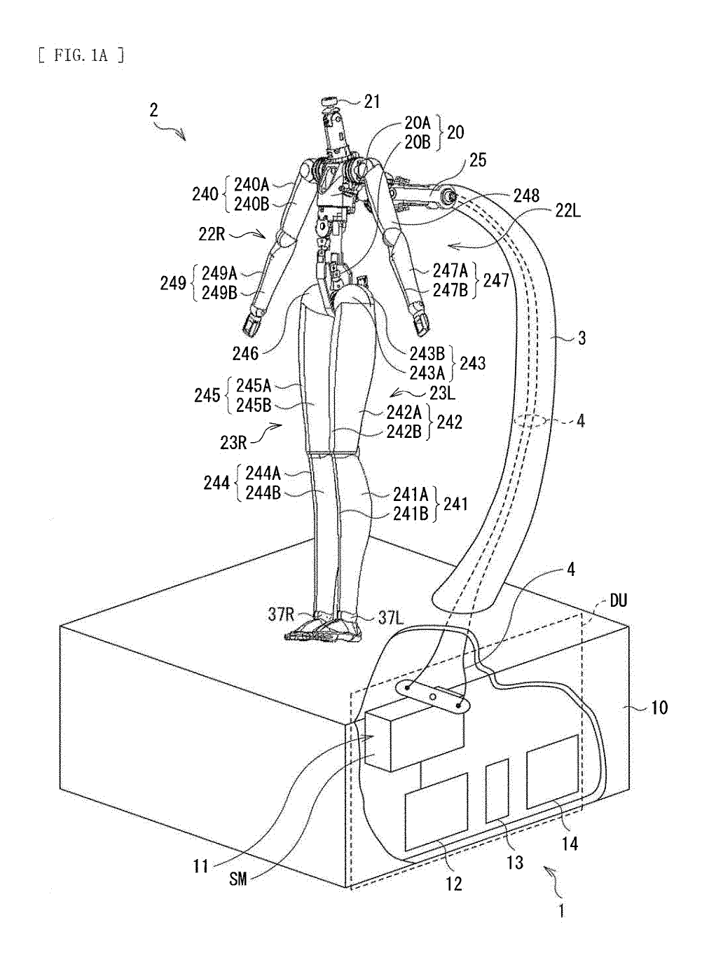

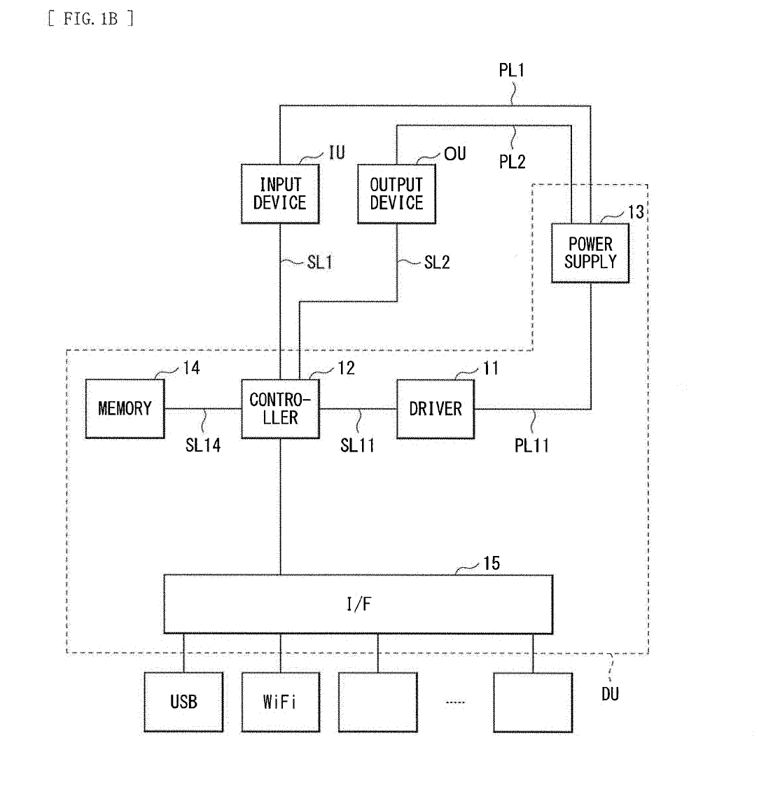

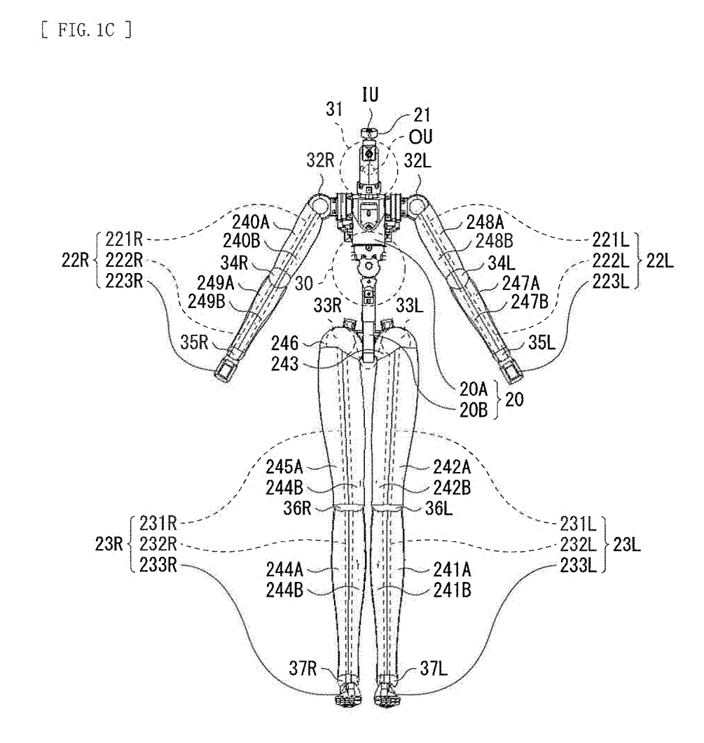

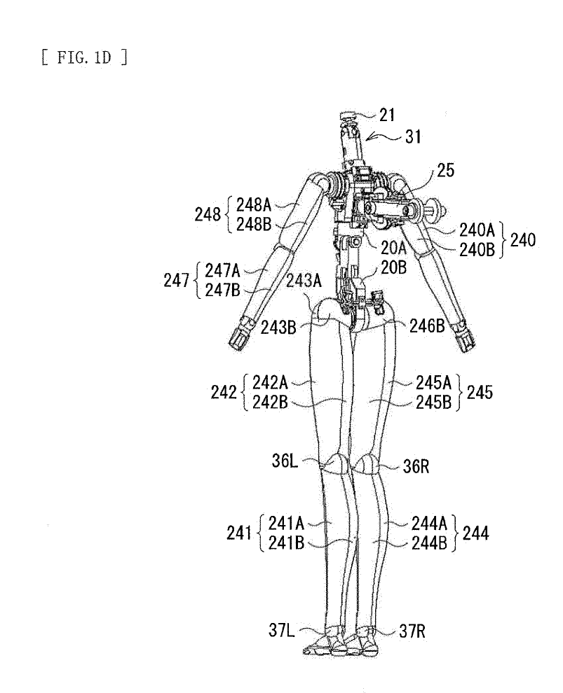

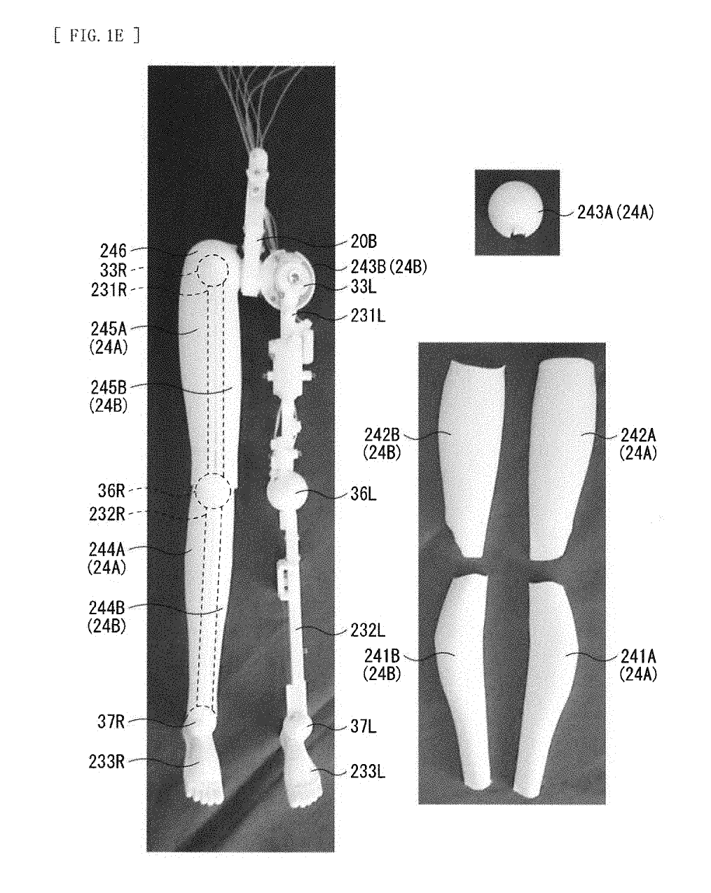

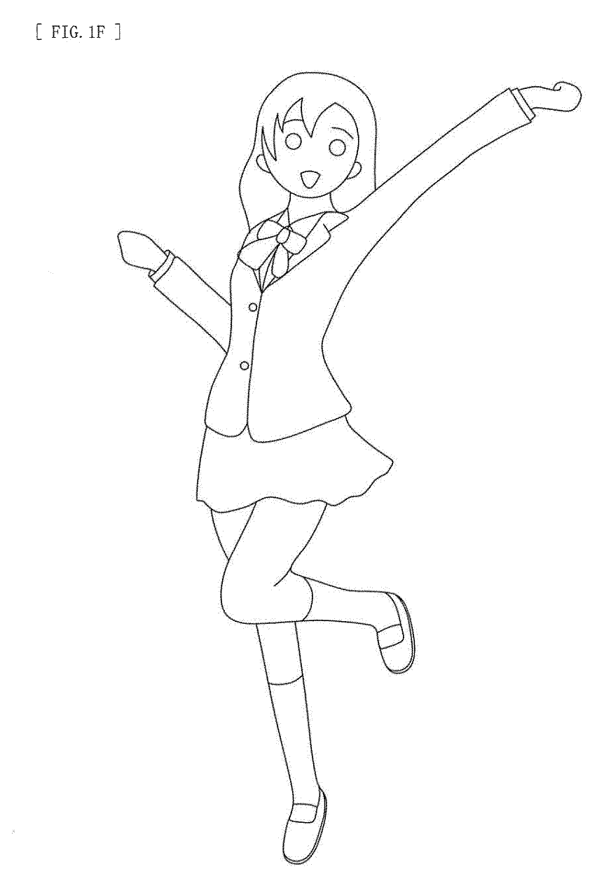

FIG. 1A is a perspective view of an appearance of an overall configuration of a figure system as a first embodiment of the disclosure. FIG. 1B is a block diagram for describing an internal mechanism of the figure system according to the present embodiment. FIG. 1C is a front view of an appearance of the figure illustrated in FIG. 1A. FIG. 1D is a perspective view of an appearance of the figure illustrated in FIG. 1A as viewed obliquely from rear side.

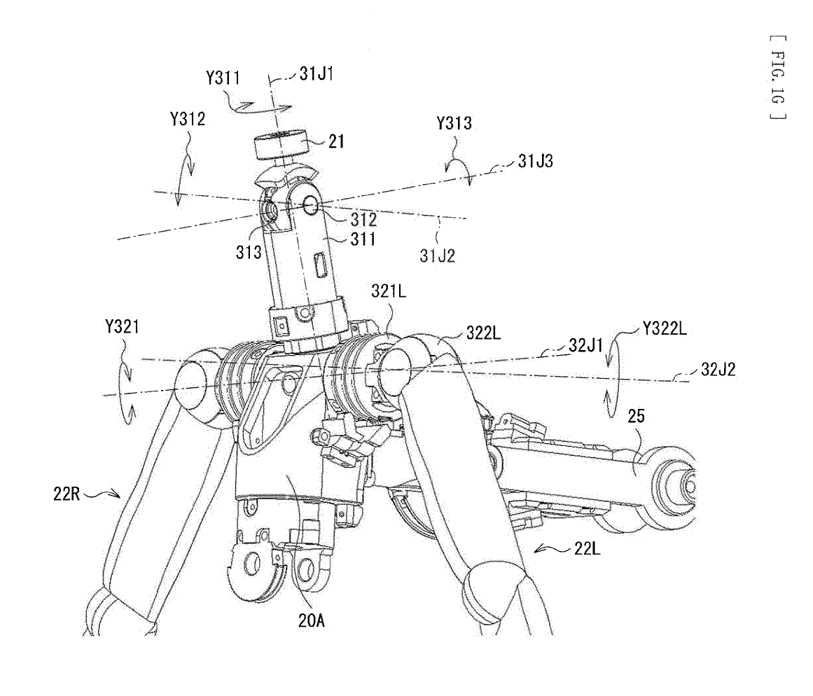

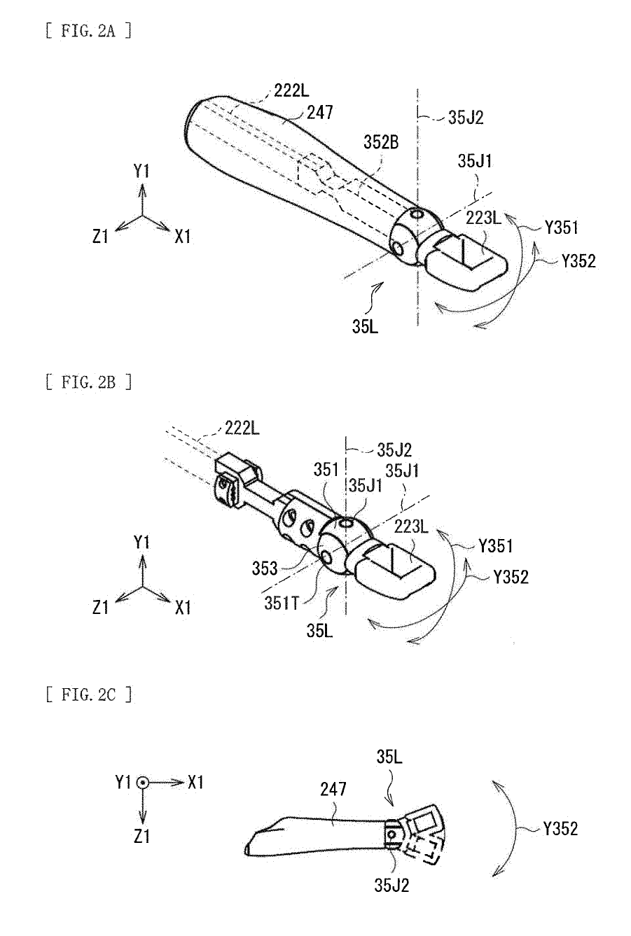

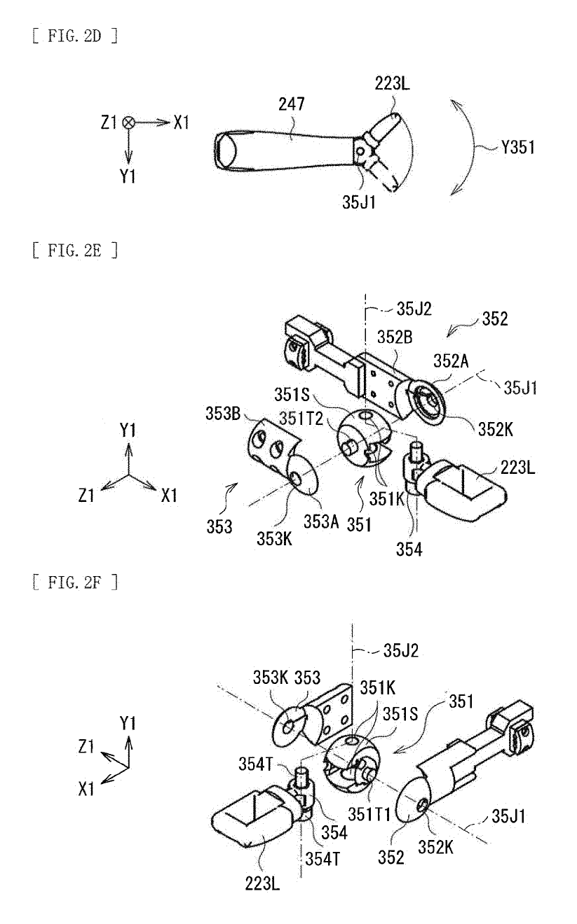

Referring to FIG. 1A, the figure system according to the present embodiment includes a base 1, a FIG. 2 disposed on the base 1, and a support 3 that couples or is configured to couple the base 1 and the FIG. 2 together. The support 3 supports the FIG. 2 above the base 1 to allow the FIG. 2 to operate freely using a torso 20 as a point of support.

Referring to FIGS. 1A, 1C, and 1D, the FIG. 2 may include, as its bone members, the torso 20, a head 21, a right arm 22R, a left arm 22L, a right leg 23R, and a left leg 23L, for example. The bone members each may be made of a high-stiffness material having a shape such as a plate shape and a rod shape. A cross-section that is orthogonal to a longitudinal direction of any bone member may have a shape such as circle, ellipse, and polygon including quadrangle. The bone member may have a solid structure; however, it is desirable that the bone member have a hollow structure for weight saving. The torso 20 may have a configuration in which an upper torso 20A and a lower torso 20B are coupled together through a waist joint 30, for example. A back of the upper torso 20A is provided with a coupler 25 that couples the torso 20 (the upper torso 20A) and the support 3 together. The head 21, the right arm 22R, the left arm 22L, the right leg 23R, and the left leg 23L are respectively coupled to the torso 20 by a neck joint 31, a shoulder joint 32R, a shoulder joint 32L, a hip joint 33R, and a hip joint 33L that serve as joints. The plurality of bone members are coupled through the plurality of joints in this way, thereby forming a framework in the FIG. 2. Note that the right arm 22R, the left arm 22L, the right leg 23R, and the left leg 23L are each so provided with a cover 24 as to incorporate therein the framework. The cover 24 (240 to 249) is equivalent to a skin. The cover 24 may be made of a hard resin such as polyvinyl chloride (PVC). As in the photograph illustrated in an exploded manner in FIG. 1E, for example, the cover 24 may be configured by two parts 24A and 24B that are halved members of a tubular member. Note that FIG. 1E illustrates photographs of parts of the lower torso 20B as well as the right leg 23R and the left leg 23L, of the FIG. 2, in an exploded manner. The hip joint 33R and the hip joint 33L may also be covered, respectively, with substantially spherical covers 246 and 243 each having an outer surface including a spherical surface. Referring to FIG. IF, the FIG. 2 may have, as a further upper layer of the cover 24, clothing of a type of a character on which the FIG. 2 is based as a motif.

The right arm 22R includes an upper arm 221R, a forearm 222R, and a hand 223R. The upper arm 221R has one end coupled to a right end of the upper torso 20A through the shoulder joint 32R, and the other end coupled to the forearm 222R by an elbow joint 34R. The forearm 222R has one end coupled to the upper arm 221R through the elbow joint 34R, and the other end coupled to the hand 223R by a hand joint 35R. The hand 223R has one end coupled to the forearm 222R through the hand joint 35R, and the other end provided with, for example, five fingers. The upper arm 221R has its own circumference covered with a cover 240A and a cover 240B, and the forearm 222R has its own circumference covered with a cover 249A and a cover 249B.

The left arm 22L has a structure that bears a symmetrical relationship to the right arm 22R about the torso 20. Specifically, the left arm 22L includes an upper arm 221L, a forearm 222L, and a hand 223L. The upper arm 221L has one end coupled to a left end of the upper torso 20A through the shoulder joint 32L, and the other end coupled to the forearm 222L by an elbow joint 34L. The forearm 222L has one end coupled to the upper arm 221L through the elbow joint 34L, and the other end coupled to the hand 223L by a hand joint 35L. The hand 223L has one end coupled to the forearm 222L through the hand joint 35L, and the other end provided with, for example, five fingers. The upper arm 221L has its own circumference covered with a cover 248A and a cover 248B, and the forearm 222L has its own circumference covered with a cover 247A and a cover 247B.

The right leg 23R includes a thigh 231R, a lower leg 232R, and a foot 233R. The thigh 231R has one end coupled to a right end of the lower torso 20B through the hip joint 33R, and the other end coupled to the lower leg 232R by a knee joint 36R. The lower leg 232R has one end coupled to the thigh 231R through the knee joint 36R, and the other end coupled to the foot 233R by an ankle joint 37R. The foot 233R has one end coupled to the lower leg 232R through the ankle joint 37R, and the other end provided with, for example, five fingers, as illustrated in FIG. 1E. The thigh 231R has its own circumference covered with a cover 245A and a cover 245B, and the lower leg 232R has its own circumference covered with a cover 244A and a cover 244B.

The left leg 23L has a structure that bears a symmetrical relationship to the right leg 23R about the torso 20. Specifically, the left leg 23L includes a thigh 231L, a lower leg 232L, and a foot 233L. The thigh 231L has one end coupled to a left end of the lower torso 20B through the hip joint 33L, and the other end coupled to the lower leg 232L by a knee joint 36L. The lower leg 232L has one end coupled to the thigh 231L through the knee joint 36L, and the other end coupled to the foot 233L by an ankle joint 37L. The foot 233L has one end coupled to the lower leg 232L through the ankle joint 37L, and the other end provided with, for example, five fingers, as illustrated in FIG. 1E. The thigh 231L has its own circumference covered with a cover 242A and a cover 242B, and the lower leg 232L has its own circumference covered with a cover 241A and a cover 241B.

In the present embodiment, the waist joint 30, the neck joint 31, the shoulder joints 32R and 32L, the hip joints 33R and 33L, the elbow joints 34R and 34L, the hand joints 35R and 35L, the knee joints 36R and 36L, and the ankle joints 37R and 37L are collectively referred to as joints. Note that any location other than those described above, such as a finger, may also be provided with a joint.

Referring to FIGS. 1A and 1B, the base 1 has a drive unit DU inside a housing 10. For example, the base 1 may have, as the drive unit DU, a driver 11 for driving of the FIG. 2, and a controller 12 that controls an operation of a circuitry such as the driver 11. The driver 11 may include a plurality of servomotors SM. The servomotors SM are coupled to the joints by wires 4. Preferable examples of the wire 4 may include a fishing line having a small stretch rate and a high strength, made of any of various fibers including nylon and polyvinylidene fluoride, and a metal wire having a small stretch rate and a high strength, such as a music wire. The drive unit DU may further include a power supply 13 such as a battery. Alternatively, the base 1 may be designed to receive a supply of electric power from an external power supply. Further, a configuration may be employed that allows for both the inclusion of the power supply 13 such as the battery and the reception of the supply of electric power from the external power supply. The drive unit DU may further include a memory 14 coupled to the controller 12 by a signal line SL14. The memory 14 may store programs for a motion control of the FIG. 2.

Referring to FIGS. 1A and 1B, the FIG. 2 may further include one or both of an input device IU and an output device OU. The input device IU is coupled to the controller 12 by the signal line SL1 as illustrated in FIG. 1B, and is coupled to the power supply 13 by an electric power line PL1. The output device is coupled to the controller 12 by a signal line SL2 as illustrated in FIG. 1B, and is coupled to the power supply 13 by an electric power line PL2 as illustrated in FIG. 1B. Examples of the input device IU may include an image capturing device, a microphone, and a touch sensor. Providing the input device IU allows for loading of information such as image information, sound information, and touch information into the controller 12 through the FIG. 2. Examples of the output device OU may include a speaker, an illuminator such as a light-emitting diode, a vibration device, and a display device including a liquid crystal display (LCD). Providing the output device OU allows the FIG. 2 to perform conversation and a motion both corresponding to the acquired image information and the acquired sound information.

The housing 10 so covers the driver 11 as to surround the driver 11, thereby achieving a sound insulating structure of the base 1. One reason is that an operation noise generated at the servomotors SM becomes difficult to leak to the outside owing to the structure in which the housing 10 surrounds the driver 11. Note that a thickness and a material (i.e., sound absorption characteristics) of the housing 10 may be varied on an as-needed basis depending on the number of servomotors SM and characteristics of noise such as intensity and frequency characteristics. Further, an unillustrated sheet having sound absorbency may be provided on an inner surface or an outer surface of the housing 10. It is desirable that the housing 10 be high in sealability from a viewpoint of reducing the leakage of sound from the housing 10 to the outside. On the other hand, high sealability may be expected to cause retention, inside the housing 10, of heat generated upon the operation of the servomotors SM. In this case, it is preferable that a member such as a cooling fan and a heat pipe (both of which are unillustrated) be provided at the housing 10 to perform cooling of the servomotors SM. The base 1 may also be provided therein, as the drive unit DU, with an interface (I/F) 15 that transmits and receives a signal, etc., to and from external devices as illustrated in FIG. 1B. The housing 10 of the base 1 may also have an unillustrated external connection terminal such as a terminal that complies with the universal serial bus (USB) standard, for example. Besides a wired LAN, the interface (I/F) 15 may be designed to transmit and receive a signal, etc., to and from the external devices by means of wireless communication such as Wi-Fi and a wireless LAN.

[2. Example of Detailed Configuration of Joints]

A description is given next of a configuration of the joint. Each of the joints includes one or more axial joint mechanisms. The wire 4 includes a plurality of wire elements 40 (e.g., 40A, 40B, 41A, 41B, 42A, 42B, 43A, 43B, etc.).

(Example of Configuration of Neck Joint 31)

For example, the neck joint 31 may include three axial joint mechanisms as illustrated in FIG. 1G. Specifically, the neck joint 31 includes an axial joint mechanism configured by a body 311 that pivots around an axis 31J1, an axial joint mechanism configured by a rotary member 312 that pivots around an axis 3112, and an axial joint mechanism configured by a rotary member 313 that pivots around an axis 31J3. The axis 31J1 extends in a vertical direction relative to the upper torso 20A. The axis 3112 extends in a right-left direction of the FIG. 2 relative to the body 311. The axis 31J3 extends in a front-rear direction of the FIG. 2 relative to the rotary member 312.

Providing the neck joint 31 that includes those axial joint mechanisms achieves the following behavior. For example, the body 311 pivots around the axis 31J1, whereby the head 21 rotates in the right-left direction (in a direction denoted by an arrow Y311) while the upper torso 20A of the FIG. 2 faces the front. Further, the rotary member 312 pivots around the axis 3112, whereby the head 21 tilts in the front-rear direction (in a direction denoted by an arrow Y312). Furthermore, the rotary member 313 pivots around the axis 31J3, whereby the head 21 tilts in the right-left direction (in a direction denoted by an arrow Y313) while the upper torso 20A of the FIG. 2 faces the front.

(Example of Configuration of Shoulder Joint 32L)

For example, the shoulder joint 32L may include two axial joint mechanisms as illustrated in FIG. 1G. Specifically, the shoulder joint 32L includes an axial joint mechanism configured by a rotary member 321L that pivots around an axis 32J1 and an axial joint mechanism configured by a rotary member 322L that pivots around an axis 32J2. The axis 32J1 extends in the right-left direction relative to the upper torso 20A. The axis 32J2 extends in the front-back direction of the FIG. 2 relative to the rotary member 321L. Owing to the two axial joint mechanisms included by the shoulder joint 32L, for example, the rotary member 321L pivots around the axis 32J1, whereby the left arm 22L pivots around the axis 32J1 in the front-rear direction (in a direction denoted by an arrow Y321). Further, the rotary member 322L pivots around the axis 32J2, whereby the left arm 22L pivots in an up-down direction (in a direction denoted by an arrow Y322).

Note that a description is given here with reference to examples of the neck joint 31 and the shoulder joint 32L. It is to be also noted that any other joint is provided with one or more axial joint mechanisms each including a shaft as well.

(Example of Configuration of Hand Joint 35L)

A description is given in detail, with reference to FIGS. 2A to 2F, of the hand joint 35L including two axial joint mechanisms. FIG. 2A is a perspective view of each appearance of the hand joint 35L, a cover 247 that covers the forearm 222L coupled to the hand joint 35L, and the hand 223L coupled to the hand joint 35L. FIG. 2B illustrates the forearm 222L, the hand joint 35L, and the hand 223L each illustrated in FIG. 2A, with the cover 247 (the cover 247A and 247B) being removed. FIGS. 2C and 2D each illustrate the hand 223L being moved. FIGS. 2E and 2F each illustrate the hand joint 35L being disassembled.

The hand joint 35L may include, for example, a member 351 serving as a rotary part, a member 352 and a member 353 each as a spherical member that so holds the member 351 as to interpose the member 351 therebetween, and a member 354 that is held rotatably by the member 351. The member 351, a part of the member 352, and a part of the member 353 form a substantially spherical body.

The member 351 includes an outer surface 351S that partially includes a spherical surface. The outer surface 351S has such an annular shape as to surround an axis 35J1. The member 351 has a pair of protrusions 351T1 and 351T2 on respective side surfaces. The axis 35J1 extends in a direction in which the paired protrusions 351T1 and 351T2 are connected to each other. Further, a pair of openings 351K is provided on a part of the outer surface 351S. The pair of openings 351K is provided along an axis 35J2 that is orthogonal to the axis 35J1. The member 351 is so held by the member 352 and the member 353 as to be pivotable around the axis 35J1 in a direction denoted by an arrow Y351.

The member 352 incudes a part 352A that comes into contact with a side surface of the member 351, and a part 352B to be fixed to a later-described part 353B of the member 353. The part 352A has a spherical surface on side opposite to the member 351, and has, on a part of the spherical surface, a hole 352K into which the protrusion 351T1 is inserted. The part 352B is coupled to the forearm 222L at an end part thereof on side opposite to the part 352A, as illustrated in FIG. 2A.

The member 353 incudes a part 353A that comes into contact with a side surface of the member 351, and the part 353B to be fixed to the part 352B of the member 352. The part 353A has a spherical surface on side opposite to the member 351, and has, on a part of the spherical surface, a hole 353K into which the protrusion 351T2 is inserted.

The member 354 has a pair of protrusions 354T to be inserted into the pair of openings 351K. The member 354 is so held by the member 351 as to be pivotable around the axis 35J2 in a direction denoted by an arrow Y352. Further, a part of the member 354 is fixed to the hand 223L.

(Example of Configuration of Knee Joint 36L)

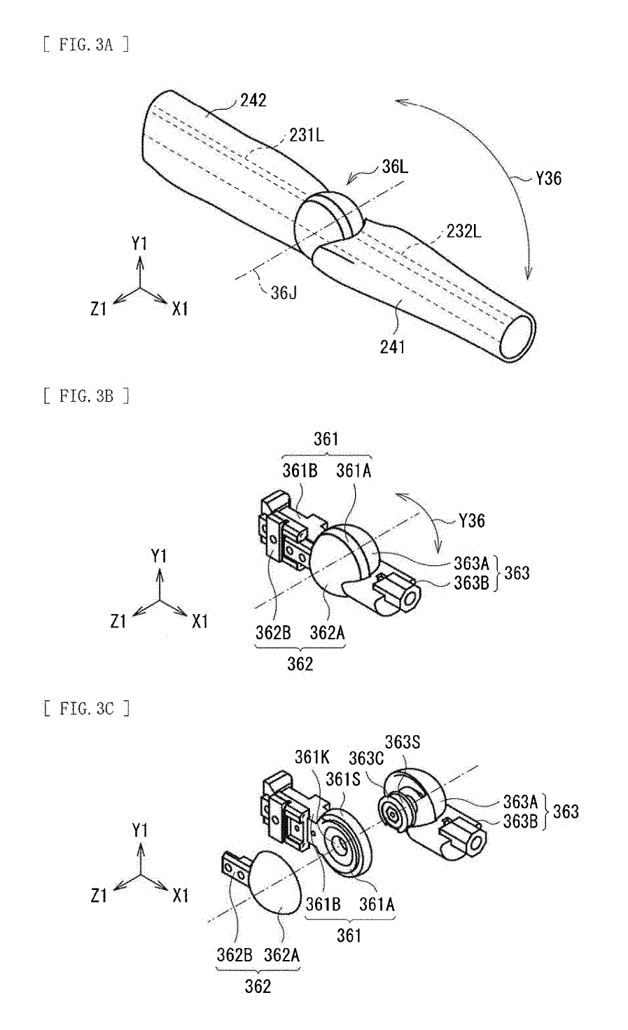

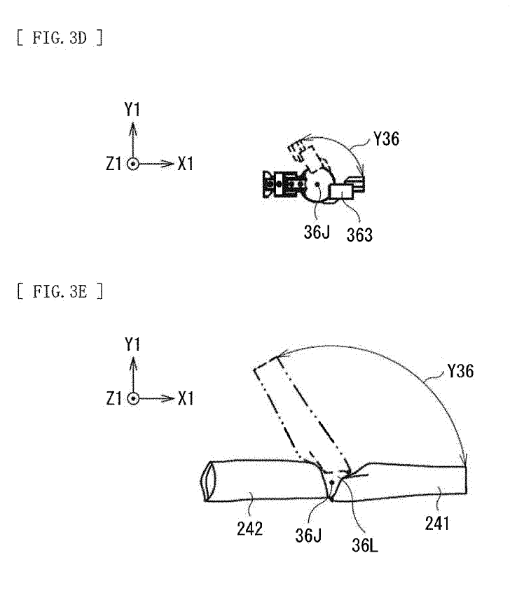

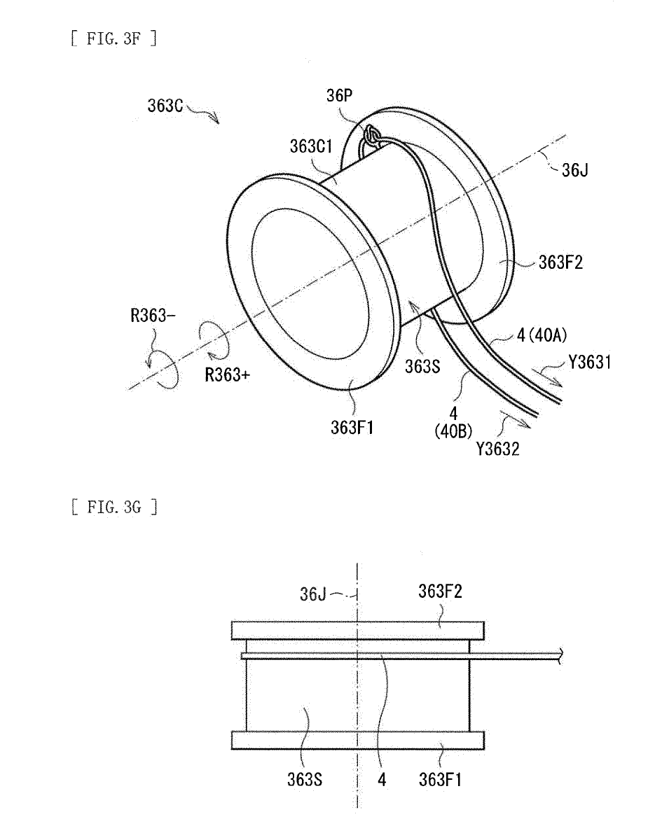

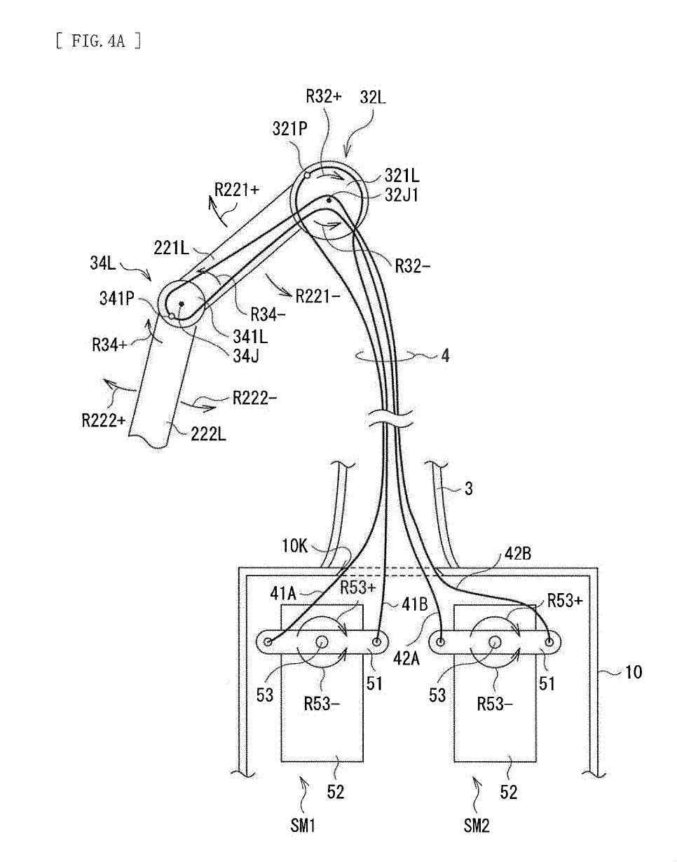

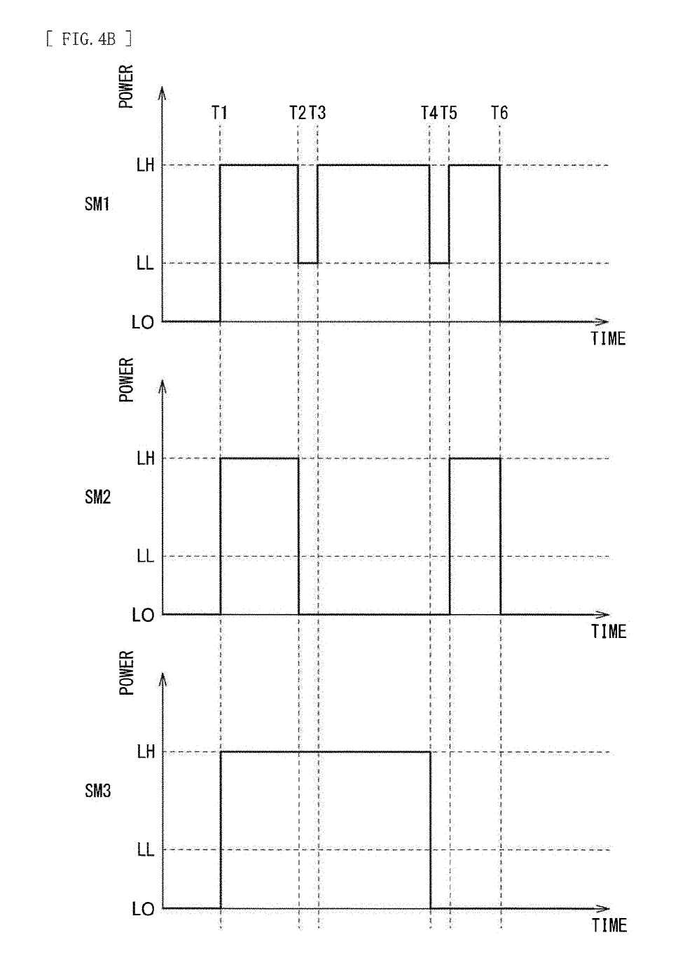

A description is given next in detail, with further reference to FIGS. 3A to 3E, of the knee joint 36L including one axial joint mechanism. FIG. 3A is a perspective view of each appearance of the knee joint 36L, a cover 242 that covers the thigh 231L coupled to the knee joint 36L, and cover 241 that covers the lower leg 232L coupled to the knee joint 36L. FIG. 3B is a perspective view of an appearance of only the knee joint 36L. FIG. 3C is an exploded perspective view of the knee joint 36L. FIG. 3D is an explanatory diagram illustrating the knee joint 36L being moved. FIG. 3E is an explanatory diagram illustrating the knee joint 36L being moved, together with the cover 242 and the cover 241.

The knee joint 36L may include, for example, a member 361 as a disk-shaped member, and a member 362 and a member 363 each as a spherical member that so holds the member 361 as to interpose the member 361 therebetween. A part of the member 361, a part of the member 362, and a part of the member 363 form a substantially spherical body as the rotary part.

The member 361 includes a part 361A and a part 361B. The part 361A forms a part of the above-described substantially spherical body as a rotary part. The part 361B has one end coupled to the part 361A, and the other end fixed to the thigh 231L. The part 361A has an outer surface 361S that partially includes a spherical surface. Thus, the member 361 has a circular outer edge in a cross-section that is orthogonal to an axis 36J. The outer surface 361S has such an annular shape as to surround the axis 36J. The member 361 has an opening 361K at its center.

The member 362 incudes a part 362A that comes into contact with the part 361A of the member 361, and a part 362B to be fixed to the part 361B of the member 361. The part 362A has a spherical surface on side opposite to the part 361A.

The member 363 incudes a part 363A that comes into contact with the part 361A, a part 363B to be coupled to the lower leg 232L, and a part 363C provided between the part 361A and the part 363A. The member 363 is so held by the member 361 and the member 362 as to be pivotable around the axis 36J in a direction denoted by an arrow Y36. The part 363A has a spherical surface on side opposite to the part 361A. FIGS. 3F and 3G each illustrate an appearance of the part 363C in an enlarged manner. FIG. 3F is an enlarged perspective view of the part 363C. FIG. 3G is an enlarged side view of an appearance of the part 363C as viewed from a direction orthogonal to the axis 36J. As illustrated in FIGS. 3F and 3G, the part 363C includes a cylindrical part 363C1 that includes an outer circumferential surface 363S so provided as to surround the axis 36J. A wire 4 is so attached to the part 363C as to surround the cylindrical part 363C1 along the outer circumferential surface 363S. Specifically, the wire 4 has a part retained at a pin 36P that serves as a retaining member and is fixed to the cylindrical part 363C1, for example. In this example, a wire element 40A is defined as a part of the wire 4 extending toward one end part from a location at which the wire 4 is retained at the pin 36P. A wire element 40B is defined as a part of the wire 4 extending toward the other end part from the location at which the wire 4 is retained at the pin 36P. The part 363C further includes a flange part 363F1 and a flange part 363F2 that stand adjacently on the outer circumferential surface 363S. The wire 4 is located between the flange part 363F1 and the flange part 363F2. Here, the part 363C rotates around the axis 36J by drive force transmitted from the wire 4, whereby the member 363 as a whole rotates around the axis 36J as illustrated in FIG. 3D.

For example, pulling the wire element 40A in a direction denoted by an arrow Y3631 causes the part 363C (the member 363) to rotate around the axis 36J in a direction denoted by an arrow R363+. Meanwhile, pulling the wire element 40B in a direction denoted by an arrow Y3632 causes the part 363C (the member 363) to rotate around the axis 36J in a direction denoted by an arrow R363−. This causes the lower leg 232L and the cover 241 to rotate around the axis 36J relative to the thigh 231L and the cover 242, as illustrated in FIG. 3E.

(Relationship between Axial Joint Mechanism and Wire)

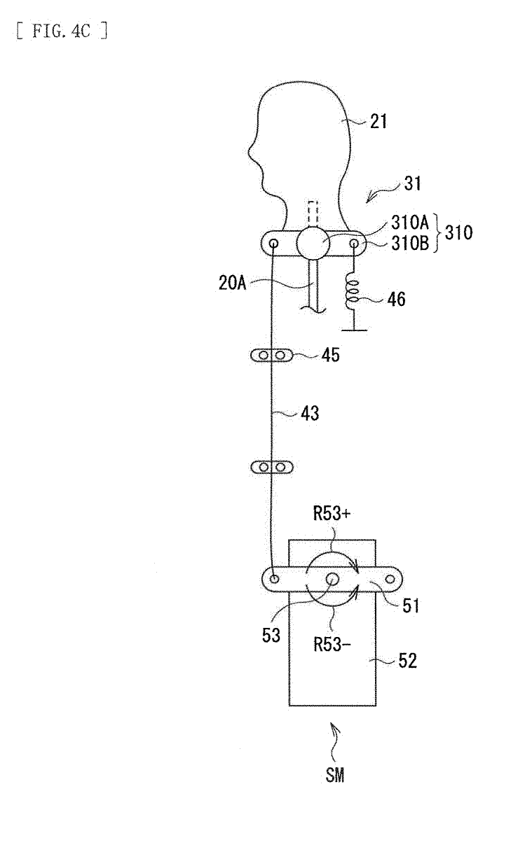

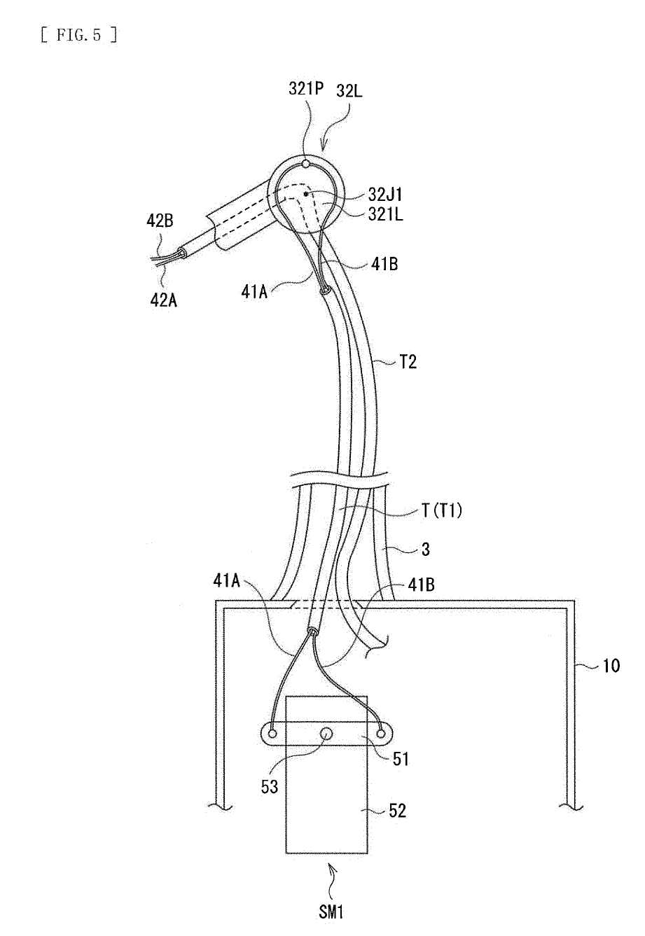

A description is given next, with reference to FIG. 4A, of a relationship between the axial joint mechanism and the wire by referring to examples of the shoulder joint 32L and the elbow joint 34L. FIG. 4A is a conceptual diagram that describes a mechanism of transmitting power from the driver 11 to the joint. Referring to FIG. 4A, the shoulder joint 32L includes the axial joint mechanism configured by the rotary member 321L illustrated in FIG. 1G. The rotary member 321L is so supported by the upper torso 20A (unillustrated in FIG. 4A) as to be rotatable around the axis 32J1. A pin 321P that serves as the retaining member is fixed to the rotary member 321L. One end of a wire element 41A and one end of a wire element 41B are attached to the pin 321P. The wire elements 41A and 41B are led along an outer edge of the rotary member 321L. Note that one end of the wire element 41A and one end of the wire element 41B may be coupled to each other.

Similarly, the elbow joint 34L may include the axial joint mechanism configured by the rotary member 341L, for example. The rotary member 341L is so supported by the upper arm 221L as to be rotatable around an axis 34J. A pin 341P that serves as the retaining member is fixed to the rotary member 341L. One end of a wire element 42A and one end of a wire element 42B are attached to the pin 341P. The wire elements 42A and 42B are led along an outer edge of the rotary member 341L. Note that one end of the wire element 42A and one end of the wire element 42B may be coupled to each other. One end of the forearm 222L is also fixed to the rotary member 341L.

As can be appreciated from the above, in the FIG. 2, the pair of wire elements 40 is provided for each axial joint mechanism. In other words, for example, the axial joint mechanism configured by the rotary member 321L may be provided with two power transmission paths, i.e., a power transmission path formed by the wire element 41A and a power transmission path formed by the wire element 41B. Note that the pair of wire elements 41A and 41B corresponds to one specific example of a “wire element pair” according to the disclosure.

The wires 4 are led along any bone member, passes through the coupler 25 provided at the back of the upper torso 20A, and eventually penetrates the inside of the support 3 to be guided to the inside of the housing 10 from an opening 10K. The other end of the wire 4 guided into the housing 10 is coupled to the servomotor SM. The servomotor SM is provided for each of the axial joint mechanisms of the joints. Specifically, referring to FIG. 4A, the other end of the wire element 41A and the other end of the wire element 41B are coupled to both ends of a servo horn 51 of the servomotor SM that corresponds to the rotary member 321L that configures the axial joint mechanism of the shoulder joint 32L (referred to as a “servomotor SM1” for the sake of convenience here). The servomotor SM1 includes a body 52 and a drive shaft 53 provided in the body 52. The servo horn 51 is fixed to the drive shaft 53, and is rotatable around the drive shaft 53 relative to the body 52. Similarly, the other end of the wire element 42A and the other end of the wire element 42B are coupled to both ends of the servo horn 51 of the servomotor SM that corresponds to the rotary member 341L that configures the axial joint mechanism of the elbow joint 34L (referred to as a “servomotor SM2” for the sake of convenience here). In this regard, it is desirable that the wire elements 42A and 42B extend through the center of the rotary member 321L that configures the other axial joint mechanism. The rotary member 321L that configures the other axial joint mechanism is located between the servomotor SM2 and the rotary member 341L that configures the axial joint mechanism corresponding to those wire elements 42A and 42B. One reason is to prevent the wire elements 42A and 42B from being loosened or being tense or receiving any other interference upon operation of any other axial joint mechanism (the rotary member 321L) located in pathways of the wire elements 42A and 42B.

Note that the shoulder joint 32L and the elbow joint 34L are exemplified here. It is to be also noted that a similar configuration is applied to a relationship among the axial joint mechanism of any other joint, the wire elements, and the servomotor as well.

[3. Basic Operation of Figure]

In the figure according to the present embodiment, the motion control of the FIG. 2 is performed on the basis of instructions given from the controller 12. Specifically, signals are transmitted to the servomotors SM that correspond to the respective joints in accordance with predetermined programs stored in the memory 14 to activate the servomotors SM (to turn the power on), and an operation of rotating the axial joint mechanisms of the respective joints is carried out to move the limbs and the body freely. Here, it is desirable that torque required for moving any servomotor SM of the driver 11 upon power-off be larger than torque derived from a weight applied to the joint corresponding to that servomotor SM. One reason is that this makes it possible to retain a posture of the FIG. 2 when the power is turned off.

Further, the controller 12 may turn the power of only some of the servomotors SM on and turn the power of the remaining servomotors SM off, instead of turning the power of all of the servomotors SM on. For example, upon moving only some of the axial joint mechanisms out of the plurality of axial joint mechanisms, the controller 12 may turn the power of some of the servomotors SM corresponding to the some of the axial joint mechanisms on for a predetermined time period, and may turn the power of the other servomotors SM off for a predetermined time period. One reason is that, even when the power of each of the servomotors SM corresponding to the respective axial joint mechanisms on which no operation is to be performed is turned off, this makes it possible to retain a posture of the FIG. 2 by taking advantage of the torque required for moving those servomotors SM as described above.

Specifically, referring to a timing chart as exemplified in FIG. 4B, for example, the first to the third servomotors SM1 to SM3 are turned on and off at their respective timings. In FIG. 4B, a horizontal axis denotes time, whereas a vertical axis denotes a level of electric power to be applied to each of the first to the third servomotors SM1 to SM3. Further, in FIG. 4B, “L0” (level zero) denotes the electric power level equivalent to that of a state in which the power is off, whereas “LL” (level low) and “LH” (level high) each denote the electric power level equivalent to that of a state in which the power is on. Specifically, the electric power level LL is equivalent to the electric power level of a standby state in which an operation of the axial joint mechanism is not performed, whereas the electric power level LH is equivalent to the electric power level of a drive state in which the operation of the axial joint mechanism is performed. In one example illustrated in FIG. 4B, the first to the third servomotors SM1 to SM3 are activated together at a time point T1, and maintain their power-on states (their drive states) until the time reaches a time point T2. In other words, the axial joint mechanisms corresponding to the respective first to third servomotors SM1 to SM3 are driven from the time point T1 to the time point T2. The first servomotor SM1 repeats a period of the standby state (a standby period) and a period of the drive state (a drive period), i.e., undergoes the standby period from the time point T2 to a time point T3, undergoes the drive period from the time point T3 to a time point T4, undergoes the standby period from the time point T4 to a time point T5, and undergoes the drive period from the time point T5 to a time point T6, following which the first servomotor SM1 is turned off. The operation of the first servomotor SM1 according to the above example involves a short interval between the previous drive period and the subsequent drive period, during which the standby period is thus set instead of a period of a power-off state (a sleep period) to thereby improve responsiveness for smooth motion of the FIG. 2. In contrast, the operation of the second servomotor SM2 involves absence of driving over a relatively long time from the time point T2 to the time point T5, during which the electric power level is thus set to “L0” to maintain the power-off state. The third servomotor SM3 maintains its drive state from the time point T1 to the time point T4, following which the servomotor SM3 enters the sleep period.

Turning the power of the servomotors SM required for the relevant motion of the FIG. 2 on only during the required time periods as described above makes it possible to reduce a drive noise derived from the driver 11 as a whole and thereby to further improve quietness. In addition thereto, it makes it possible to reduce power consumption. Further, when the interval between the previous drive period and the subsequent drive period is short, temporarily setting the low electric power level LL to provide the standby period in which the servomotor SM is temporarily halted makes it possible to start the motion promptly as compared with a case where the power is completely turned off. In this case, it is possible for the FIG. 2 to perform a more natural motion.

[4. Operation of Joint]

A description is given now, with reference to FIG. 4A, of an operation of the upper arm 221L and the forearm 222L by referring to examples of the shoulder joint 32L and the elbow joint 34L. The upper arm 221L operates by rotation of the rotary member 321L of the shoulder joint 32L. In other words, transmitting drive force derived from the servomotor SM1 to the rotary member 321L that configures the axial joint mechanism through the wire elements 41A and 41B allows for movement of the upper arm 221L. Specifically, the servomotor SM1 is driven on the basis of the signal supplied from the controller 12 to rotate its drive shaft 53 in, for example, a direction denoted by an arrow R53+ (rotated clockwise), whereby the servo horn 51 is also rotated in the same direction. This pulls the wire element 41B to cause rotation of the rotary member 321L of the shoulder joint 32L in a direction denoted by an arrow R32+ (rotated clockwise) around the axis 32J1. As a result, the upper arm 221L fixed to the rotary member 321L pivots upward (pivots in a direction in which the upper arm 221L is separated away from the torso 20) around the shoulder joint 32L as a point of support. Conversely, rotating the drive shaft 53 in a direction denoted by an arrow R53− (rotating the drive shaft 53 anticlockwise) pulls the wire element 41A, making it possible to cause the upper arm 221L to pivot in a descending direction (pivot in a direction in which the upper arm 221L comes close to the torso 20). Note that the elbow joint 34L and the forearm 222L, which are located closer to the distal end side than the shoulder joint 32L and the upper arm 221L, are hardly influenced by the movement of the shoulder joint 32L and the upper arm 221L. One reason is that the wire elements 42A and 42B are so provided as to extend through the center of the rotary member 321L.

The above applies similarly to the elbow joint 34L as well. In other words, transmitting drive force derived from the servomotor SM2 to the rotary member 341L through the wire elements 42A and 42B allows for movement of the forearm 222L. Specifically, the servomotor SM2 is driven on the basis of the signal supplied from the controller 12 to rotate its drive shaft 53 in, for example, a direction denoted by the arrow R53+ (rotated clockwise), whereby the servo horn 51 is also rotated in the same direction. This pulls the wire element 42B to cause rotation of the rotary member 341L that configures the axial joint mechanism of the elbow joint 34L in a direction denoted by an arrow R34+ (rotated clockwise) around the axis 34J. As a result, the forearm 222L fixed to the rotary member 341L pivots in a direction in which the forearm 222L becomes parallel to the upper arm 221L around the elbow joint 34L as a point of support. Conversely, rotating the drive shaft 53 in a direction denoted by the arrow R53− (rotating the drive shaft 53 anticlockwise) pulls the wire element 42A, making it possible to cause the forearm 222L to pivot in a direction in which the forearm 222L is bent relative to the upper arm 221L around the elbow joint 34L as the point of support accordingly.

Note that the technology is not limited to an example of a structure in which the pair of wire elements is provided for the single axial joint mechanism (referred to as a “twin pulling structure”). Referring by way of example to FIG. 4C, a single wire element may be solely used for any joint that requires less drive force, such as the neck joint 31 (referred to as a “single pulling structure”). Specifically, to give an example, the neck joint 31 includes an axial joint mechanism 310 having a shaft 310A and a bar 310B. The shaft 310A is fixed to an upper end of a middle part of the upper torso 20A. The bar 310B has, for example, a middle part that is rotatably supported by the shaft 310A. The wire element 43 is coupled only to one end of the bar 310B, and the other end of the wire element 43 passes through a wire guide 45 to be coupled to one end of the servo horn 51 of the servomotor SM3 that corresponds to the axial joint mechanism 310. The other end of the bar 310B is coupled to, for example, the upper torso 20A through an elastic member 46 such as a coil spring. The single pulling structure also makes it possible to perform a motion of the head 21. Specifically, rotating the drive shaft 53 in the direction denoted by the arrow R53− (rotating the drive shaft 53 anticlockwise) pulls the wire element 43, causing the bar 310B to rotate anticlockwise around the shaft 310A as a point of support and thereby making it possible to achieve a motion in which the head 21 is tilted forward (achieves a nodding motion). Conversely, rotating the drive shaft 53 in the direction denoted by the arrow R53+ (rotating the drive shaft 53 clockwise) reduces the tension applied to the wire element 43 and allows the elastic member 46 to pull the other end of the bar 310B, causing the bar 310B to rotate clockwise around the shaft 310A as the point of support and thereby making it possible to return the head 21 to its original position or to achieve a motion of looking up above.

[5. Workings and Effects]

The figure system according to the present embodiment includes the base 1 containing the driver 11 that drives the FIG. 2. This eliminates the necessity of mounting a drive source on the FIG. 2, making it possible to achieve weight saving of the FIG. 2 and also achieve the FIG. 2 having superior aesthetic appearance. For example, it is possible to achieve the slim FIG. 2. Further, the weight saving of the FIG. 2 makes it possible to keep an output of the servomotor SM required for driving low. This in turn makes it possible to further increase a size of the FIG. 2, and achieves advantages such as lower costs and elimination of risks upon a fall even when the FIG. 2 is increased in size. Further, the drive force derived from the servomotor SM of the driver 11 is transmitted to any of the respective joints through the wire 4 for the driving of the FIG. 2. Hence, it is possible to stabilize the motion of the FIG. 2 and achieve high reproducibility of the motion. Moreover, it is possible to achieve a high degree of freedom of motion easily as compared with a case in which a member such as a shaft, a cam, and a gear is used as a drive force transmission member.

In the figure system according to the present embodiment, the rotary part in the axial joint mechanism includes an arc part in at least a part of the outer edge in the cross-section that is orthogonal to the rotation axis. This, for example, allows for easing of interference or friction with clothing or covering that covers the FIG. 2 upon operation. Hence, it becomes possible to perform a wider variety of motions of the FIG. 2 stably and smoothly.

In particular, the rotary part in the axial joint mechanism, such as the rotary member 322L (as illustrated in FIG. 1G), has an outer surface including a spherical surface, for example. This makes it possible to achieve the joint having a high degree of aesthetic appearance. Similar effects are also achieved in a case where the hip joint 33R and the hip joint 33L are covered, respectively, with substantially spherical covers 246 and 243 having the outer surface including the spherical surface, as illustrated in FIG. 1E, for example. Forming the joint into a substantially spherical body or into a shape having an outer spherical surface also makes interference less likely to occur between the cover 24 that covers the bone member and the spherical body of the joint upon operation of the joint. For example, in the example illustrated in FIGS. 3A to 3E, a spacing between the knee joint 36L and the cover 241 is less likely to vary, thus making the interference between the knee joint 36L and the cover 241 less likely to occur. This allows for stable operation without increasing load to be applied to the wire element 40 upon operation. Further, it is possible to employ a hard resin material to configure the joint, thus suppressing deterioration in dimensional accuracy due to factors such as deformation. Consequently, it becomes possible to achieve both improvement in aesthetic appearance of the FIG. 2 and smooth operation of the FIG. 2.

Further, in the figure according to the present embodiment, one or two or more axial joint mechanisms are provided per joint, and the axial joint mechanisms are individually driven by the wire 4 provided for each of the axial joint mechanisms. Hence, it is possible to achieve a wider variety of motions depending on each site.

In particular, leading the wires 4 into the housing 10 while gathering the wires 4 only at one of the foot 233R and the foot 233L makes it possible to keep the number of locations at which the FIG. 2 is fixed to the base 1 to a minimum. This allows the other foot to perform an up-and-down motion and a rotary motion freely, and eases restrictions on factors such as orientations and postures of the body as a whole as compared with an example where both feet are fixed. Hence, it is possible to allow for relatively free poses that meet user's needs and allow for a reduced feeling of visual strangeness.

Moreover, in the figure according to the present embodiment, the driver 11 is incorporated in the base 1, and the housing 10 is so provided as to cover the driver 11 to achieve the sound insulating structure. This makes it possible to ensure quietness upon operation. Hence, it is possible for a user to operate the figure for enjoyment without feeling uneasy about surroundings of the user even under a quiet environment, such as in the home and during the night.

The figure according to the present embodiment as described therefore makes it possible to achieve a wider variety of motions that suit user's preferences easily while ensuring aesthetic appearance of the FIG. 2.

<2. Modification Examples of First Embodiment>

(Modification Example 1-1)

A description is given, with reference to FIG. 5, of a first modification example (modification example 1-1) of the figure according to the foregoing first embodiment. In the present modification example, the wire 4 extends through tubes T (a tube T1 and a tube T2) and provided for each of the corresponding axial joint mechanisms. Specifically, the pair of wire elements 41A and 41B provided corresponding to the rotary member 321L is contained in a single tube T1, for example. Further, the pair of wire elements 42A and 42B provided corresponding to the rotary member 341L (unillustrated in FIG. 5) is contained in a single tube T2. The tubes T1 and T2 are provided along the bone member of the FIG. 2, and may be provided inside the cover 24. The tubes T1 and T2 may have a region that is fixed to the bone member by a holder. The tubes T1 and T2 may be so provided as to pass through internal space of any bone member in an example where the bone member has the hollow structure. The tubes T may be made of a resin such as Teflon (Registered Trademark of E. I. du Pont de Nemours and Company) and have inner surfaces that involve a small friction coefficient to the respective wire elements 40.

In the present modification example, the pair of wire elements 41A and 41B are provided in the single tube T1 for each of the corresponding axial joint mechanisms. This prevents interference between one pair of wire elements and another pair of wire elements that moves any other axial joint mechanism (for example, generation of friction resulting from overlapping) even upon performing a motion that involves a large twist of the torso 20, i.e., even when performing a motion in which the upper torso 20A is rotated at a large angle relative to the lower torso 20B. This also prevents the pair of wire elements 41A and 41B from being damaged due to a difference in level between one structure and another structure that are located in the pathway of the pair of wire elements 41A and 41B. This further prevents the pair of wire elements 41A and 41B from being bent due to a motion of the FIG. 2. Hence, operability and a degree of freedom of posture are improved, making it possible to perform a more dynamic motion smoothly. In addition, the pathways along which the wires 4 pass are held stably at appropriate positions, making it possible to reproduce a more accurate motion. Further, the tubes T are provided inside the cover 24 of the FIG. 2, preventing impairment of aesthetic appearance originating from the FIG. 2 as a whole and preventing the tubes T from interfering with the limbs including the head 21, the right arm 22R, the left arm 22L, the right leg 23R, and the left leg 23L as well. The configuration in which the wires 4 travel through the inside of the tubes T allows for easier work of putting the wires 4 into the bone members, and is thus superior in manufacturability. Similarly, the configuration is also superior in maintainability in that replacement of the wires 4 is relatively easy even upon repair.

(Modification Example 1-2)

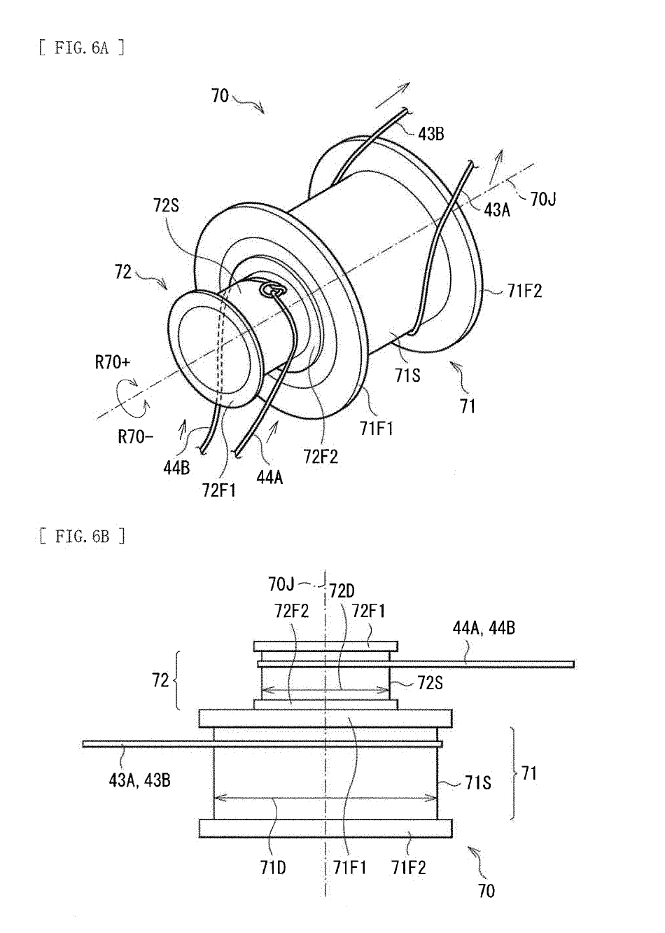

A description is given, with reference to FIGS. 6A and 6B, of a second modification example (modification example 1-2) of the figure according to the foregoing first embodiment. The present modification example involves transmitting the drive force derived from the servomotor SM that serves as one actuator to a corresponding one of the axial joint mechanisms via a deceleration mechanism 70. The deceleration mechanism 70 includes a rotating body 71 and a rotating body 72. The rotating body 71 and the rotating body 72 are each substantially cylindrical and rotate around a coaxial axis 70J. The rotating body 71 has a diameter 71D in a cross-section that is orthogonal to the axis 70J, and has a circumferential surface 71S. Meanwhile, the rotating body 72 has a diameter 72D, which is smaller than the diameter 71D, in a cross-section that is orthogonal to the axis 70J, and has a circumferential surface 72S. Each one end of a pair of wire elements 43A and 43B is fixed to the circumferential surface 71S. The wire elements 43A and 43B are each provided along the circumferential surface 71S in such a direction as to surround the axis 70J. Similarly, each one end of a pair of wire elements 44A and 44B is fixed to the circumferential surface 72S. The wire elements 44A and 44B are each provided along the circumferential surface 72S in such a direction as to surround the axis 70J.

Pulling the wire element 43A, for example, causes the deceleration mechanism 70 to rotate in a direction denoted by R70−. In this case, tension to be applied to the wire element 44A is increased. Pulling the wire element 43B causes the deceleration mechanism 70 to rotate in a direction denoted by R70+. In this case, tension to be applied to the wire element 44B is increased. In this situation, the diameter 72D of the rotating body 72, to which the wire elements 44A and 44B are attached, is smaller than the diameter 71D of the rotating body 71. The drive force is transmitted to the wire elements 44A and 44B. Consequently, larger drive force is transmitted to the wire elements 44A and 44B. On the other hand, an amount of movement of the wire elements 44A and 44B caused by the rotation of each of the rotating body 71 and the rotating body 72 are smaller than an amount of movement of the wire elements 43A and 43B. The intervention of the deceleration mechanism 70 thus allows a finer motion to be performed with high accuracy.

<3. Second Embodiment>

[1. Configuration of Detachment Unit]

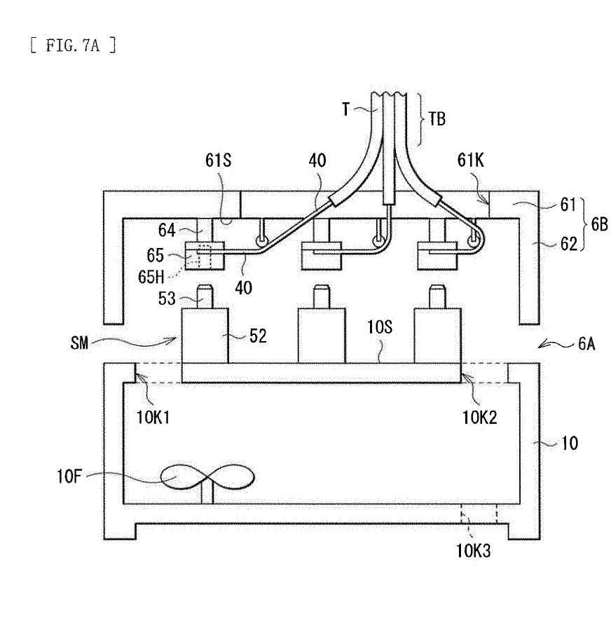

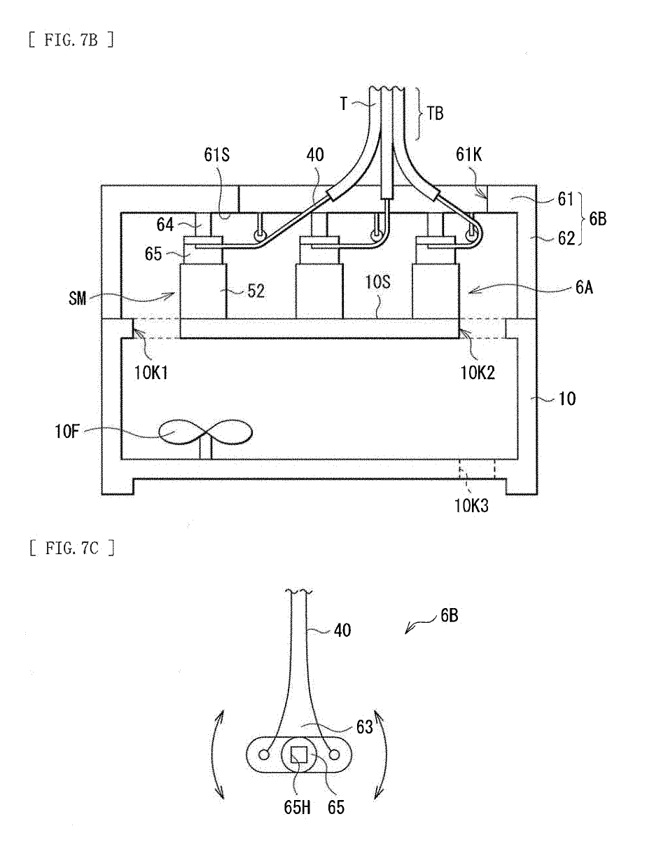

A description is given of a figure system according to a second embodiment of the disclosure. Referring to FIGS. 7A and 7B, for example, the base 1 includes a detachment unit 6A on an upper part of the housing 10, and the FIG. 2 includes a detachment unit 6B on a lower part of the FIG. 2, allowing the detachment units 6A and 6B to be detachably coupled to each other, according to the present embodiment. Otherwise, the present embodiment has a configuration similar to the configuration according to the foregoing first embodiment. Employing the configuration allows for easier handling, and allows for sharing of the single base 1 between the plurality of FIGS. 2 as long as the compatibility is ensured.

Specifically, referring to FIG. 7A, the base 1 has an array of servomotors SM on an upper surface 10S of the housing 10, forming the detachment unit 6A. The detachment unit 6B provided at the FIG. 2 is so coupled to the detachment unit 6A as to be placed over the detachment unit 6A as illustrated in FIG. 7B. FIG. 7A schematically illustrates a configuration of the detachment units 6A and 6B and a configuration near the detachment units 6A and 6B in a state before the coupling, i.e., in a state of being spaced apart from each other. FIG. 7B schematically illustrates a configuration of the detachment units 6A and 6B and a configuration near the detachment units 6A and 6B in a state after the coupling, i.e., in a state of being coupled to each other. Further, FIG. 7C is a front view of a configuration of the detachment unit 6B and a configuration near the detachment unit 6B.

In the detachment unit 6A, each of the servomotors SM disposed on the upper surface 10S has the drive shaft 53 on an upper surface of the body 52. The drive shaft 53 extends in a substantially vertical direction relative to the upper surface 10S.

Meanwhile, the detachment unit 6B is located above the detachment unit 6A, and includes a base part 61, a wall 62 that stands on the periphery of the base part 61, and a servo horn 65 supported by a lower surface 61S of the base part 61 with a rotary shaft 64 interposed therebetween. A bearing hole 65H of the servo horn 65 that faces the drive shaft 53 of the servomotor SM extends in substantially the same direction as that of the drive shaft 53. The drive shaft 53 is inserted into and thus coupled to the bearing hole 65H of the servo horn 65. Note that the tubes T containing the respective wire elements 40 extend upward through an opening 61K provided on the base part 61, and form a single bundled section TB as the bundle of the plurality of tubes T.

The figure system achieves the sound insulating structure that surrounds the plurality of servomotors SM by means of the coupling of the detachment units 6A and 6B. The sound insulating structure makes it difficult for an operation noise generated at the servomotors SM to leak to the outside. In this case, a fan 10F may be provided inside the housing 10 as illustrated in FIGS. 7A and 7B as a cooler that cools the servomotors SM, for example. The fan 10F may be so disposed on a lower part of the housing 10 as to be oriented upward to send the air upward, for example. The upper part of the housing 10 has ventilation openings 10K1 and 10K2, allowing an airflow to circulate within internal space formed in each of the detachment unit 6B and the housing 10 upon operation of the fan 10F while the detachment units 6A and 6B are coupled to each other. The airflow travels upward from the fan 10F to pass through the ventilation opening 10K1, the servomotor SM, and the ventilation opening 10K2 sequentially, following which the airflow returns to the fan 10F again. The bottom of the housing 10 may have one or more ventilation openings 10K3 to allow for exhaustion and intake of the air to and from the outside in an example where heat remains inside the housing 10. In this case, sound insulation properties will not be severely impaired owing to the provision of the ventilation opening 10K3 on the bottom of the housing 10. Alternatively, a surrounding part of the ventilation opening 10K3 may be covered with a material having superior ventilation characteristics and high sound insulating properties.

The signal lines SL1 and SL2, the electric power lines PL1 and PL2, and other various wiring lines are designed to be connectable and separable at a junction of the detachment units 6A and 6B. With this configuration, it is possible to connect and separate the various wiring lines collectively in response to the fitting and the separation of the drive shafts 53 of the respective servomotors SM and the bearing holes 65H of the respective servo horns 65.

[2. Workings and Effects]

The figure according to the present embodiment as described allows the base 1 and the FIG. 2 to be coupled to each other detachably at the detachment units 6A and 6B. This allows for easier handling, and allows for sharing of the single base 1 between the plurality of FIGS. 2 as long as the compatibility is ensured. Hence, it is advantageous in terms of user's convenience and economic efficiency. It is also possible to allow for easier identification of a cause of failure upon occurrence of the failure and easier repair. Further, ends of the respective wires 4 led from the FIG. 2 are coupled to the detachment unit 6B instead of being joined to the servomotors SM of the driver 11. Hence, it is possible to separate the figure system into a mechanical system part (the FIG. 2) and an electrical system part (the base 1) completely, and to make it superior in manufacturability and maintainability accordingly.

The figure according to the present embodiment therefore makes it possible to increase user satisfaction even more.

<4. Third Embodiment>

[1. Overall Configuration]

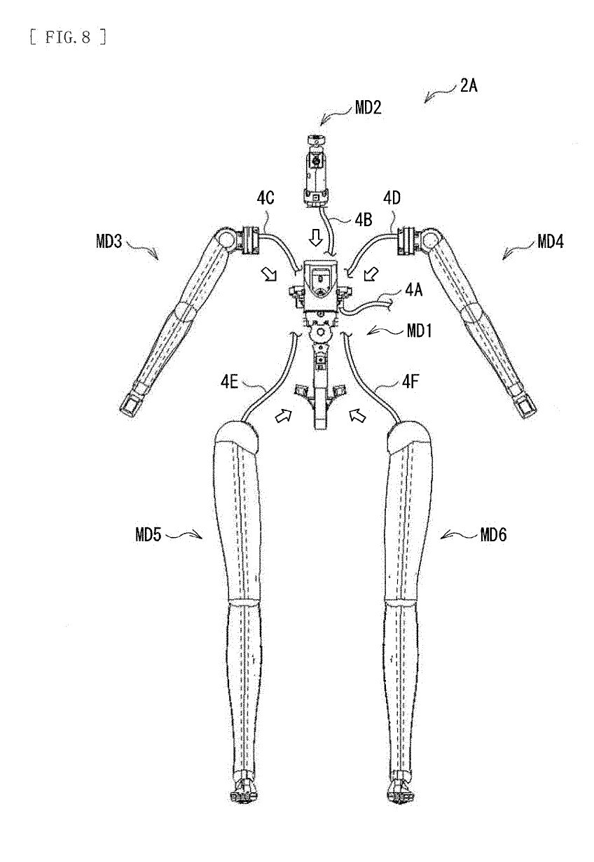

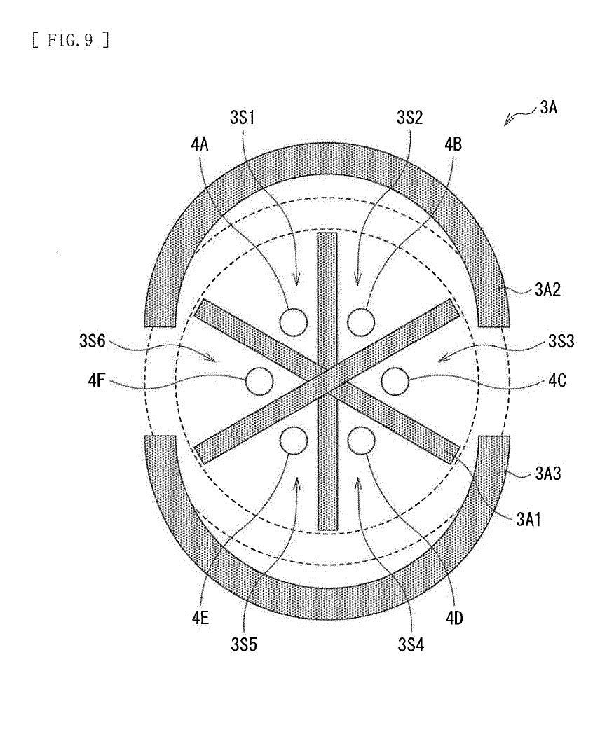

A description is given, referring to FIGS. 8 and 9, of a figure system according to a third embodiment of the disclosure. The figure system according to the present embodiment includes a FIG. 2A and a support 3A that supports the FIG. 2A. The FIG. 2A includes a plurality of modules MD that are coupled together and each include one or a plurality of axial joint mechanisms. FIG. 8 schematically illustrates an overall configuration of the FIG. 2A according to the present embodiment. FIG. 9 illustrates a cross-sectional configuration of the support 3A according to the present embodiment.

Specifically, referring to FIG. 8, the FIG. 2A includes a torso module MD1, a head module MD2, a right arm module MD3, a left arm module MD4, a right leg module MDS, and a left leg module MD6. The torso module MD1, the head module MD2, the right arm module MD3, the left arm module MD4, the right leg module MDS, and the left leg module MD6 are hereinafter collectively denoted simply as a module MD. Each module MD includes the bone member and the axial joint mechanism. For each axial joint mechanism, one end of the wire 4 is coupled, and the other end of the wire 4 is pulled to the outside. The wire 4 includes a plurality of wire elements 40, and, for example, one wire element 40 may be contained in one tube T. Further, a plurality of tubes T containing respective wire elements 40 may be bundled for corresponding one of the axial joint mechanisms.

In the FIG. 2A, the head module MD2, the right arm module MD3, and the left arm module MD4 are each fixed to the upper torso 20A of the torso module MD1 by means of fitting or by means such as screwing and adhesion. Specifically, as for the head module MD2, for example, the body 311 of the neck joint 31 is fixed to an upper part of the upper torso 20A. As for the right arm module MD3 and the left arm module MD4, for example, a part of the shoulder joint 32R and a part of the shoulder joint 32L (for example, rotary members 321R and 321L) are fixed to respective sides of the upper torso 20A.

Further, the right leg module MD5 and the left leg module MD6 are each fixed to the lower torso 20B of the torso module MD1 by means of fitting or by means such as screwing and adhesion. Specifically, as for the right leg module MD5 and the left leg module MD6, for example, a part of the hip joint 33R and a part of the hip joint 33L are fixed to respective sides of the lower torso 20B.

The support 3A includes a stay 3A1 that has a plurality of slots 3S1 to 3S6 as illustrated in FIG. 9. The slots 3S1 to 3S6 are each provided to extend in a direction in which the base 1 and the FIG. 2A are connected to each other. Wires 4A to 4F of the respective torso module MD1, head module MD2, right arm module MD3, left arm module MD4, right leg module MD5, and left leg module MD6 are assigned to and contained in the slots 3S1 to 3S6, respectively. The support 3A further includes covers 3A2 and 3A3 to cover the stay 3A1 from the outside and to contain the wires 4A to 4F inside. This allows for improvement in aesthetic appearance and allows for easy replacement of the wires 4A to 4F upon an occasion such as repair.

[2. Workings and Effects]

In the figure system according to the present embodiment, the FIG. 2A includes a plurality of modules coupled together. Thus, each of the modules MD is individually manufactured, and the modules MD are finally assembled to thereby complete the FIG. 2A. This allows for improvement in productivity. Further, the FIG. 2A allows for easy and quick repair, etc., owing to replacement which is performable in the FIG. 2A on a module basis. Hence, improvement in maintainability is also expected.

Further, the stay 3A1 has the slots 3S1 to 3S6 to which the wires 4A to 4F corresponding to the respective modules MD are assigned. Hence, it is easy to perform the replacement operation on a module MD basis.

<Other Modification Examples>

Although the disclosure has been described in the foregoing with reference to some embodiments and some modification examples, the disclosure is not limited thereto but may be modified in a wide variety of ways. For example, any other simplified actuator, such as a polymer actuator and a solenoid actuator, may also be used as the drive source. It is to be also noted that a servomotor may be used to drive directly any joint that requires greater drive force. In any case, a combination of different kinds of actuators may be used depending on application and usage.

(First Other Modification Example)

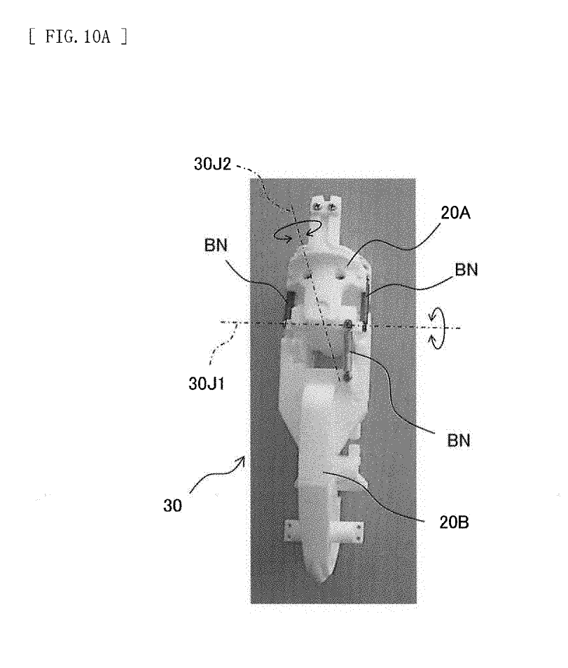

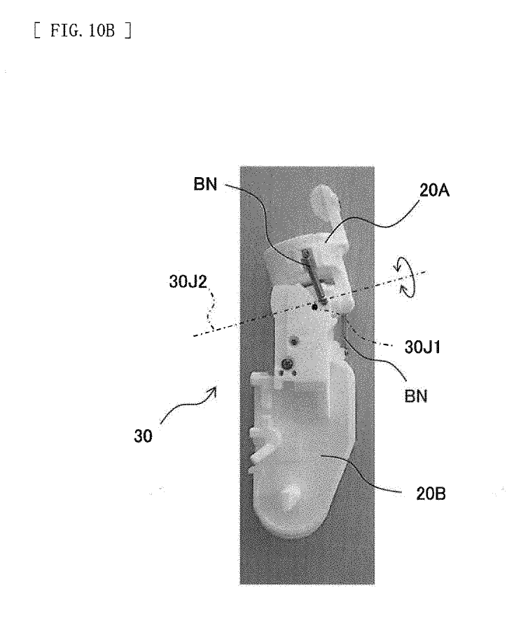

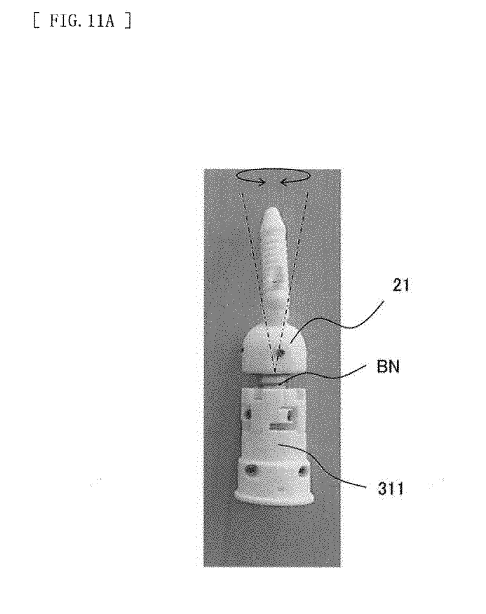

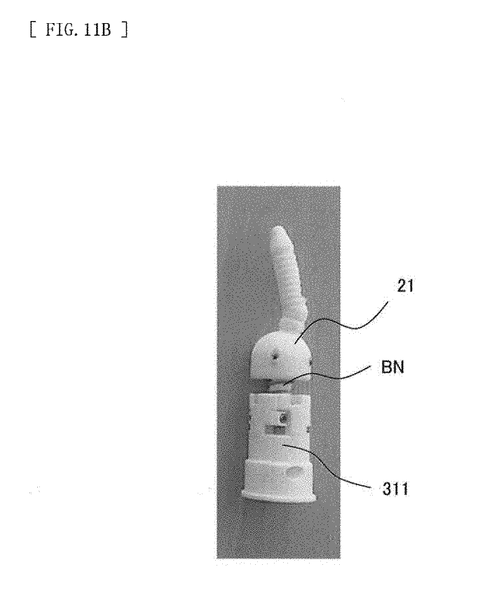

Referring to FIGS. 10A and 10B, for example, in the disclosure, the upper torso 20A provided rotatably relative to the lower torso 20B may be held in a neutral posture by means of biasing force of a plurality of coil springs BN. For example, the upper torso 20A is configured rotatably around each of a rotation axis 30J1 and a rotation axis 30J2 that are orthogonal to each other. The neutral posture as used herein refers to a posture in a state where drive force derived from all of the wire elements 40 coupled to the waist joint 30 is not transmitted to the waist joint 30. Elastically supporting the upper torso 20A relative to the lower torso 20B using the plurality of coil springs BN makes it possible to prevent wobbling of the waist joint 30, etc., in the neutral posture, and to facilitate smooth operation of the FIG. 2. Note that the biasing force derived from the coil spring BN is weaker than drive force derived from the driver 11, i.e., pulling force provided by the wire element 40. Consequently, the rotary operation, provided by the driver 11, of the axial joint mechanism in the waist joint 30 is not inhibited. It is to be noted that FIGS. 10A and 10B are, respectively, an enlarged front view and an enlarged side view of the waist joint 30 that serves as a coupler between the lower torso 20B and the upper torso 20A.

(Second Other Modification Example)

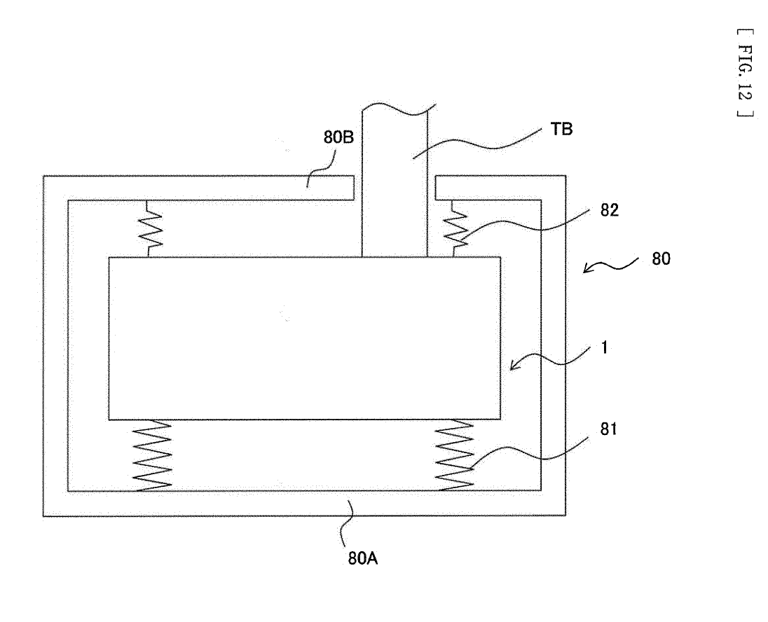

FIGS. 10A and 10B illustrate the waist joint 30 being supported using the plurality of coil springs; however, the disclosure is not limited thereto. Referring to FIGS. 11A and 11B, for example, the head 21 may be elastically supported relative to the body 311 of the neck joint 31 using one coil spring BN. FIGS. 11A and 11B are, respectively, an enlarged front view and an enlarged side view of a vicinity of the neck joint 31 that serves as a coupler between the upper torso 20A and the head 21. The number of the coil spring BN and the biasing force of the coil spring BN may be selected in consideration of a weight of each of the components of the FIG. 2. Further, an elastic member such as a plate spring and rubber, or any other biasing member such as an oil damper may be used instead of the coil spring BN.

(Third Other Modification Example)

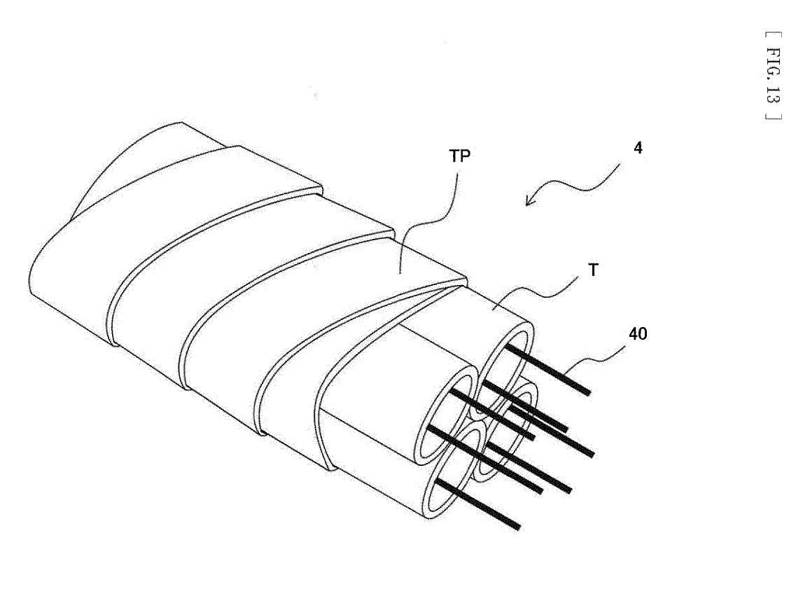

Further, referring to FIG. 12, the base 1 may be disposed inside a sound-proof case 80. In this case, the base 1 may be placed on a bottom plate 80A of the sound-proof case 80, for example, with a damper 81 as a buffer member being interposed therebetween. Furthermore, an upper part of the base 1 may be connected to a top plate 80B of the sound-proof case 80 by an elastic member such as a coil spring 82. With such a structure, a noise caused by the driver 11 provided inside the base 1 is less likely to be transmitted to the sound-proof case 80 via the housing 10. This allows for reduction in the noise of the driver 11, etc. to be leaked to the outside.

(Fourth Other Modification Example)

Furthermore, the plurality of tubes T containing the respective wire elements 40 may be divided into groups for each adjacent axial joint mechanism, for example; the plurality of tubes T may be bundled for each of the groups. In this case, referring to FIG. 13, for example, the plurality of tubes T may be wrapped by a tape TP made of a resin film, etc. This avoids a circumstance in which the tubes T may be tangled with one another near the torso 20 where many tubes T are gathered, for example. In this situation, the tape TP may be colored in different colors for respective groups in order to enhance discriminability.

According to the foregoing embodiments and their modification examples, the wires 4 are guided to the inside of the FIG. 2 from the back of the torso 20. The wires 4, however, may be guided to the inside of the figure through any other part (such as a bottom of the foot) of the figure.

According to the foregoing second embodiment, the FIG. 2 may further include a memory that may be ROM or any other memory. The FIG. 2 may further include a memory even when a configuration is employed in which the base 1 and the FIG. 2 are inseparable as in the first embodiment.

The plurality of signal lines and the plurality of electric power lines each may be shared by some devices. Further, the signal line may be used as the electric power line and vice versa.

The joints exemplified in the foregoing embodiments and their modification examples are illustrative and thus the technology is not limited to an example where the foregoing joints are all provided. Alternatively, any other joint may be provided. Further, the figure unit is not limited to a doll. For example, the figure unit may represent, as its motif, an animal in nature such as a dog. The figure unit may also represent, as its motif, an imaginary character or a fantasy-based character.

Moreover, the figure unit may have an overall size that is reduced to, for example, about 15 cm to about 30 cm, or may be a life-size figure.

Moreover, according to the technology, a unit such as the base unit and the figure unit may be provided with various devices such as a display, an acoustic device including a speaker, and a projector.

Note that effects described herein are illustrative only. Effects are not limited to those described herein, and effects other than those described herein may be exerted as well.

It should be understood by those skilled in the art that various modifications, combinations, sub-combinations and alterations may occur depending on design requirements and other factors insofar as they are within the scope of the appended claims or the equivalents thereof.

A figure system according to the disclosure may have the following industrial applicability.

For example, the figure system according to the disclosure may be installed in an amusement machine such as a pachinko pinball machine and a stationary game console to allow for a large variety of motions performed in conjunction with the amusement machine. The figure system according to the disclosure achieves a reduction in size and weight, and is thus suitable for the above applications. Further, the figure system according to the disclosure may be disposed in a vehicle interior of an automobile, such as on a dashboard. In this case, an operation performed in conjunction with, e.g., a car navigation system, such as a route guidance and communication of information, may be performed. The wording “operation performed in conjunction with” as used herein may refer, for example, to performing of an output of the figure (such as performing a mechanical motion, outputting sound, and outputting light) on the basis of a signal derived from software of the car navigation system. Alternatively, any signal may be transmitted from the figure to the car navigation system to perform a control of the car navigation system.

The figure system according to the disclosure makes it possible to dispose electrical system parts collectively at the base, and thereby achieve a waterproof structure relatively easily. Hence, the figure system is suitable for applications that involve outdoor installation.

The figure system according to the disclosure disposes the heavy drivers collectively at the base, making it possible to achieve weight saving of the figure. Thus, the figure system is superior in safety and allows for installation in the presence of a crowd of people as well. Hence, for example, the figure system is suitable as a guide around a crowded shop, in a museum, etc.

The figure system according to the disclosure has applicability to: a watch-over system directed to an elderly person, a pet, etc., in an ordinary household; and a monitoring system for an empty home. The figure system according to the disclosure may be equipped with a communication function to allow for, for example, two-way communication with the outside and a control performed from the outside. For example, an alarm may be outputted to the outside in the event of abnormality. Alternatively, image data may be acquired periodically to transmit the data to the outside in the event of the abnormality. Moreover, a two-way conversation may be performed.

The figure system according to the disclosure also allows for support of a learner, in conjunction with an educational application installed on a personal computer, etc. To give an example of possible use, the figure system may operate while giving commentary on study contents, within a range of information prepared in advance or on the basis of information acquired by communication with the outside. Another example of possible use may be to perform coaching, such as determining whether a leaner's answer is correct or wrong and indicating a part with wrong answer, within the range of information prepared in advance or on the basis of information acquired by communication with the outside.

The figure system according to the disclosure has applicability as a device that gives commentary related to broadcast contents in conjunction with a television broadcast or a radio broadcast, or performs communication of information related to the broadcast contents in conjunction with the television broadcast or the radio broadcast. In this case, the figure system may, for example, give commentary on broadcast data by voice while causing arms and legs to perform any motion. Further, the figure system according to the disclosure has applicability as a device that performs communication of information through Internet connection in conjunction with an information terminal such as a personal computer. The figure system according to the disclosure is small and light, and allows the drivers to be disposed collectively at one place. Hence, the figure system may be connected to the information terminal as a decorative accessory such as an information terminal charm.

The figure system according to the disclosure has applicability as a toy that dances in conjunction with music production software. For example, the figure system according to the disclosure may be operated on the basis of program instructions of music software. Alternatively, the figure system may also be utilized as a device that captures a human motion in conjunction with a capture device and reproduces the same motion (i.e., mimics a motion). Further, the figure system may also be utilized as a device that performs a motion in conjunction with a game console or game software. Performing a motion same as or corresponding to a motion of a character on a two-dimensional screen makes it possible to increase a realistic sensation of a game player. Possible examples may include causing the figure system to perform a motion of an opponent's character in conjunction with display performed on the two-dimensional screen and causing the figure system to perform a motion of a user's character not displayed on the two-dimensional screen, in a match-up game such as a fighting game and a sports game.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A figure system comprising:
a drive unit including a plurality of actuators; and
a figure including one or a plurality of axial joint mechanisms, the axial joint mechanisms each including a rotary part that is provided rotatably around a rotation axis, wherein
drive force derived from one of the plurality of actuators is transmitted to corresponding one of the plurality of axial joint mechanisms through a wire, and
the rotary part has an arc shape at least in a part of an outer edge in a cross-section that is orthogonal to the rotation axis.

2. The figure system according to claim 1, wherein the rotary part has an outer surface that includes a spherical surface.

3. The figure system according to claim 1, wherein the rotary part is covered with a cover having an outer surface that includes a spherical surface.

4. (canceled)

5. (canceled)

6. The figure system according to claim 2, wherein the rotary part includes a disk-shaped member having a circular outer edge in the cross-section that is orthogonal to the rotation axis, and a pair of spherical members facing each other along the rotation axis with the disk-shaped member being interposed therebetween, and each including the spherical surface.

7-10. (canceled)

11. A figure system comprising:
a drive unit including a plurality of actuators; and
a figure including a plurality of modules that are coupled together, and each include one or a plurality of axial joint mechanisms, wherein
drive force derived from one of the plurality of actuators is transmitted to corresponding one of the plurality of axial joint mechanisms through a wire.

12. The figure system according to claim 11, further comprising:
a base that contains the drive unit; and
a support that couples or is configured to couple the base and the figure to each other, the support having a plurality of grooves in each of which the wire is contained, the plurality of grooves each extending in a direction in which the base and the figure are connected to each other.

13. The figure system according to claim 11, wherein the one or plurality of axial joint mechanisms each include a rotary part that is provided rotatably around a rotation axis, the rotary part has an arc shape at least in a part of an outer edge in a cross-section that is orthogonal to the rotation axis.

14. The figure system according to claim 13, wherein the rotary part has an outer surface that includes a spherical surface.

15. The figure system according to claim 14, wherein the rotary part includes a disk-shaped member having a circular outer edge in the cross-section that is orthogonal to the rotation axis, and a pair of spherical members facing each other along the rotation axis with the disk-shaped member being interposed therebetween, and each including the spherical surface.

16. (canceled)

17. The figure system according to claim 1, further comprising a base that contains the drive unit, wherein the figure is placed or is configured to be placed on the base.

18. A figure comprising:
one or a plurality of axial joint mechanisms each including a rotary part that is provided rotatably around a rotation axis;
a detachment unit configured to be coupled to a drive unit including a plurality of actuators; and
a wire that extends from corresponding one of the plurality of axial joint mechanisms to the detachment unit, wherein the rotary part has an arc shape at least in a part of an outer edge in a cross-section that is orthogonal to the rotation axis.

19. A figure comprising:
a plurality of modules that are coupled together, and each include one or a plurality of axial joint mechanisms;
a detachment unit configured to be coupled to a drive unit including a plurality of actuators; and
a wire that extends from corresponding one of the plurality of axial joint mechanisms to the detachment unit.

20-25. (canceled)
